(19) United States
(12) Patent Application Publication
(10) Pub. No.: US 2025/0001386 A1
(43) Pub. Date: Jan. 2, 2025

(54) METHOD AND SYSTEM FOR CONTROLLING A MICROWAVE-ASSISTED TREATMENT

(71) Applicant: PYROWAVE INC., Montreal (CA)

(72) Inventors: Jean-Philippe Laviolette, Montreal (CA); Jocelyn Doucet, Montreal (CA); Benoit Sevigny, Montreal (CA)

(21) Appl. No.: 18/705,302

(22) PCT Filed: Oct. 28, 2022
(86) PCT No.: PCT/IB2022/060406

§ 371 Date: Apr. 26, 2024

Related U.S. Application Data
(60) Provisional application No. 63/263,173, filed on Oct. 28, 2021.

(51) Int. Cl. B01J 19/12

(52) U.S. Cl. CPC B01J 19/126; B01J 2219/1281; B01J 2219/1284

(57) ABSTRACT

A method for controlling a microwave-assisted treatment including: injecting an initial substance into a cavity; propagating microwaves into the cavity, thereby obtaining a treated substance; extracting the treated substance; injecting part of the extracted substance into the cavity; measuring a complex reflection coefficient; comparing the measured complex reflection coefficient to a target value; when the measured complex reflection coefficient is different from the target value, measuring operation parameters; comparing the measured operation parameters to given operation parameters; when the measured operation parameters correspond to the given operation parameters: removing a contaminant from the treated substance prior to injection into the microwave cavity; and/or varying a quantity of a given element within the microwave cavity, the given element comprising a catalyst, a microwave receptor, a reagent or an additive.

### FIELD

The present technology pertains to the field of microwave systems, and more particularly to methods and systems for controlling microwave-assisted treatment performed in a microwave system.

### BACKGROUND

Microwave cavities are usually used to perform a treatment on a substance and/or sustain (and/or trigger) phenomena such as a chemical reaction, a plasma, etc. In at least some instances, the control of the electromagnetic conditions inside the microwave cavity is key for optimal operation of such devices. For example, the geometry of the microwave cavity, the electromagnetic properties of the mixture inside the cavity, the geometrical disposition of certain elements inside the cavity are all parameters that may have an impact on the electromagnetic properties of the microwave cavity. The reactive nature of the phenomenon occurring inside the cavity involves possible changes in operating conditions inside the microwave cavity over time. These changes may be due to equipment failure, change in feed/output conditions, changes in temperature, changes in hydrodynamic regime and/or changes in reaction rates all affecting the composition of the mixture as well as the way it is geometrically disposed inside the microwave cavity. Therefore, all of the above will have an impact on the steady state conditions prevailing inside the cavity and potentially affecting the microwave cavity stability and performance.

Therefore, there is a need for a method and system of controlling a microwave-assisted treatment of a substance.

### SUMMARY

According to a first brad aspect, there is provided a method for controlling a microwave-assisted treatment, the method comprising: injecting an initial substance having a given composition into a microwave cavity; propagating microwaves into the microwave cavity according to given operation parameters, thereby obtaining a treated substance; extracting some of the treated substance from the microwave cavity; injecting at least part of the extracted treated substance into the microwave cavity; measuring a complex reflection coefficient of a microwave system comprising the microwave cavity and at least a microwave source; comparing the measured complex reflection coefficient to a target coefficient value for the given composition of the initial substance and for the given operation parameters; when the measured complex reflection coefficient is different from the target coefficient value, measuring operation parameters of the microwave system; comparing the measured operation parameters to the given operation parameters; when the measured operation parameters correspond to the given operation parameters, at least one of: removing a contaminant from the at least a part of the treated substance prior to said injecting the at least a part of the treated substance into the microwave cavity; and varying a quantity of a given element within the microwave cavity, the given element comprising one of a catalyst, a microwave receptor, a reagent and an additive.

In one embodiment, the contaminant comprises carbon black.

In one embodiment, the step of removing the contaminant comprises propagating the at least a part of the treated substance into a separator, thereby obtaining a separated substance, the separated substance being injected into the microwave cavity.

In one embodiment, the method further comprises determining a rate of production of the contaminant within the microwave cavity based on the measured complex reflection coefficient and controlling the separator based on the determined rate of production.

In one embodiment, the method further comprises determining a rate of production of the contaminant within the microwave cavity based on the measured complex reflection coefficient and adjusting a flow rate of the at least a part of the treated substance provided to the separator based on the determined rate of production.

In one embodiment, the step of propagating the at least a part of the treated substance into the separator comprises propagating the at least a part of the treated substance into a centrifuge.

In one embodiment, the method further comprises determining a rate of production of the contaminant within the microwave cavity based on the measured complex reflection coefficient and controlling at least one of a temperature, a bowl rotational speed and a differential speed for the centrifuge based on the determined rate of production.

In one embodiment, the step of propagating the at least a part of the treated substance into the separator comprises filtering the at least a part of the treated substance using a filter.

In one embodiment, the method further comprises determining a rate of production of the contaminant within the microwave cavity based on the measured complex reflection coefficient and adjusting at least one of a mesh size and a filter cleaning sequence for the filter based on the determined rate of production.

In one embodiment, the step of propagating the at least a part of the treated substance into the separator comprises propagating the at least a part of the treated substance into one of a desorption device and an adsorption device.

In one embodiment, the step of varying the quantity of the given element comprises varying a flow rate at which the given element is injected into the microwave cavity.

In one embodiment, the method further comprises determining a quantity of the given element within the microwave cavity based on the measured complex reflection coefficient, said varying the quantity of the given element being performed based on the determined quantity of the given element.

In one embodiment, the step of measuring the operation parameters comprising determining at least one of:
a frequency of the microwaves propagated into the microwave cavity;
a net power of the microwaves propagated into the microwave cavity;
a geometry of the microwave cavity;
a level of the initial substance undergoing the microwave-assisted
treatment within the microwave cavity;
a first temperature of the initial substance undergoing the microwave-assisted treatment within the microwave cavity;
a second temperature of the microwave receptor; and
a rotation speed of an agitator contained within the microwave cavity.

In one embodiment, the step of injecting the at least part of the treated substance into the microwave cavity comprises injecting the at least part of the treated substance into a storage tank fluidly connected to the microwave cavity.

In one embodiment, the step of measuring the complex reflection coefficient of the microwave system comprises measuring a complex transmission coefficient of the microwave system.

In one embodiment, the step of measuring the complex reflection coefficient is performed using one of a reflectometer and a network analyzer.

In one embodiment, the step of measuring the complex reflection coefficient is performed at an interface between the microwave cavity and the microwave source.

In one embodiment, the microwave system further comprises a coupler installed between the microwave source the microwave cavity, said measuring the complex reflection coefficient being performed at an interface between the microwave cavity and the coupler.

According a second broad aspect, there is provided a microwave system for performing a microwave-assisted treatment, the system comprising: a microwave cavity for receiving an initial substance having a given composition, the microwave being operatively connected to at least a microwave source for propagating microwaves into the microwave cavity according to given operation parameters to obtain a treated substance; a separator fluidly connected to the microwave cavity for receiving at least a part of the treated substance therefrom, removing a contaminant from the at least a part of the treated substance said to obtain a separated substance and injecting the separated substance into the microwave cavity; a source of a given element fluidly connected to the microwave cavity for injecting the given element into the microwave cavity, the given element comprising one of a catalyst, a microwave receptor, a reagent and an additive; a coefficient sensor for measuring a complex reflection coefficient of the microwave system; at least one operation sensor for measuring operation parameters of the microwave system; and a controller for: comparing the measured complex reflection coefficient to a target coefficient value for the given composition of the initial substance and for the given operation parameters; when the measured complex reflection coefficient is different from the target coefficient value, controlling the at least one operation sensor for measuring the operation parameters of the microwave system; comparing the measured operation parameters to the given operation parameters; when the measured operation parameters correspond to the given operation parameters, at least one of: removing a contaminant from the at least a part of the treated substance prior to said injecting the at least a part of the treated substance into the microwave cavity; and varying a quantity of the given element within the microwave cavity.

In one embodiment, the contaminant comprises carbon black.

In one embodiment, the controller is further configured for determining a rate of production of the contaminant within the microwave cavity based on the measured complex reflection coefficient and controlling the separator based on the determined rate of production.

In one embodiment, the controller is further configured for determining a rate of production of the contaminant within the microwave cavity based on the measured complex reflection coefficient and adjusting a flow rate of the at least a part of the treated substance provided to the separator based on the determined rate of production.

In one embodiment, the separator comprises a centrifuge. In one embodiment, the controller is further configured for determining a rate of production of the contaminant within the microwave cavity based on the measured complex reflection coefficient and controlling at least one of a temperature, a bowl rotational speed and a differential speed for the centrifuge based on the determined rate of production.

In one embodiment, the separator comprises a filter. In one embodiment, the controller is further configured for determining a rate of production of the contaminant within the microwave cavity based on the measured complex reflection coefficient and adjusting at least one of a mesh size and a filter cleaning sequence for the filter based on the determined rate of production.

In one embodiment, the separator comprises one of a desorption device and an adsorption device.

In one embodiment, the controller is configured for varying a flow rate at which the given element is injected into the microwave cavity in order to vary the quantity of the given element comprises.

In one embodiment, the controller is further configured for determining a quantity of the given element within the microwave cavity based on the measured complex reflection coefficient and for said varying the quantity of the given element based on the determined quantity of the given element.

In one embodiment, the operation parameters comprise at least one of:
a frequency of the microwaves propagated into the microwave cavity;
a net power of the microwaves propagated into the microwave cavity;
a geometry of the microwave cavity;
a level of the initial substance undergoing the microwave-assisted treatment within the microwave cavity;
a first temperature of the initial substance undergoing the microwave-assisted treatment within the microwave cavity;
a second temperature of the microwave receptor; and
a rotation speed of an agitator contained within the microwave cavity.

In one embodiment, the system further comprises a storage tank fluidly connected the microwave cavity and the separator, said injecting the separated substance into the microwave cavity comprising injecting the separated substance into the storage tank.

In one embodiment, the complex reflection coefficient of the microwave system comprises a complex transmission coefficient of the microwave system.

In one embodiment, the coefficient sensor comprises one of a reflectometer and a network analyzer.

According a third broad aspect, there is provided a method for detecting a failure in a microwave system comprising at least a microwave cavity and a microwave source during a microwave-assisted treatment of a mixture, the method comprising: injecting an initial substance having a given composition into the microwave cavity; propagating microwaves into the microwave cavity, thereby obtaining a treated substance; measuring a complex reflection coefficient of a microwave system at different points in time, the microwave system comprising the microwave cavity and at least a microwave source; determining a rate of change of the measured complex reflection coefficient; comparing the determined rate of change to a threshold value for the given composition; and when the determined rate of change is above the threshold value, triggering an alarm.

In one embodiment, a value of the rate of change of the measured complex reflection coefficient above the threshold value is indicative of a given cause of failure of the microwave system.

In one embodiment, the step of triggering an alarm comprises outputting an identification of the given source of failure.

In one embodiment, the step of triggering the alarm comprises shutting down the microwave system.

In one embodiment, the method further comprises: extracting some of the treated substance from the microwave cavity; injecting at least part of the extracted treated substance into the microwave cavity; and when the determined rate of change is below the threshold value: comparing the measured complex reflection coefficient to a target coefficient value for the given composition of the initial substance and for given operation parameters of the microwave system; when the measured complex reflection coefficient is different from the target coefficient value, measuring operation parameters of the microwave system; comparing the measured operation parameters to the given operation parameters; when the measured operation parameters correspond to the given operation parameters, at least one of: removing a contaminant from the at least a part of the treated substance prior to said injecting the at least a part of the treated substance into the microwave cavity; and varying a quantity of a given element within the microwave cavity, the given element comprising one of a catalyst, a microwave receptor, a reagent and an

In one embodiment, the contaminant comprises carbon black.

In one embodiment, the step of removing the contaminant comprises propagating the at least a part of the treated substance into a separator, thereby obtaining a separated substance, the separated substance being injected into the microwave cavity.

In one embodiment, the step of measuring the complex reflection coefficient is performed using one of a reflectometer and a network analyzer.

In one embodiment, the step of measuring the complex reflection coefficient comprises measuring a complex transmission coefficient.

In one embodiment, the step of said measuring the complex reflection coefficient is performed at an interface between the microwave cavity and the microwave source.

In one embodiment, the microwave system further comprises a coupler installed between the microwave source the microwave cavity, said measuring the complex reflection coefficient is performed at an interface between the microwave cavity and the coupler.

According to another broad aspect, there is provided a microwave system for performing a microwave-assisted treatment, the system comprising: a microwave cavity for receiving an initial substance having a given composition, the microwave being operatively connected to at least a microwave source for propagating microwaves into the microwave cavity to obtained a treated substance; a coefficient sensor for measuring a complex reflection coefficient of the microwave system at different points in time; and a controller for: determining a rate of change of the measured complex reflection coefficient; comparing the determined rate of change to a threshold value for the given composition; and when the determined rate of change is above the threshold value, triggering an alarm.

In one embodiment, a value of the rate of change of the measured complex reflection coefficient above the threshold value is indicative of a given cause of failure of the microwave system.

In one embodiment, the controller is further configured for outputting an identification of the given source of failure.

In one embodiment the controller is configured for shutting down the microwave system.

In one embodiment, the system further comprises: a separator fluidly connected to the microwave cavity for receiving at least a part of the treated substance therefrom, removing a contaminant from the at least a part of the treated substance said to obtain a separated substance and injecting the separated substance into the microwave cavity; a source of a given element fluidly connected to the microwave cavity for injecting the given element into the microwave cavity, the given element comprising one of a catalyst, a microwave receptor, a reagent and an additive; and at least one operation sensor for measuring operation parameters of the microwave system; wherein when the determined rate of change is below the threshold value, the controller is further configured for: comparing the measured complex reflection coefficient to a target coefficient value for the given composition of the initial substance and for given operation parameters of the microwave system; when the measured complex reflection coefficient is different from the target coefficient value, measuring operation parameters of the microwave system; comparing the measured operation parameters to the given operation parameters; when the measured operation parameters correspond to the given operation parameters, at least one of: removing a contaminant from the at least a part of the treated substance prior to said injecting the at least a part of the treated substance into the microwave cavity; and varying a quantity of a given element within the microwave cavity.

In one embodiment, the contaminant comprises carbon black.

In one embodiment, the controller is further configured for determining a rate of production of the contaminant within the microwave cavity based on the measured complex reflection coefficient and at least one of: adjusting a flow rate of the at least a part of the treated substance provided to the separator based on the determined rate of production; and controlling the separator based on the determined rate of production.

In one embodiment, the coefficient sensor comprises one of a reflectometer and a network analyzer.

In one embodiment, the complex reflection coefficient of the microwave system comprises a complex transmission coefficient of the microwave system.

In one embodiment, the coefficient sensor is positioned at an interface between the microwave cavity and the microwave source.

In one embodiment, the microwave system further comprises a coupler installed between the microwave source the microwave cavity and the coefficient sensor is positioned at an interface between the microwave cavity and the coupler.

In accordance with another broad aspect, there is provided a method for controlling the composition of a mixture inside a microwave cavity in which a microwave-assisted treatment occurs, the method comprising: injecting an initial substance into the microwave cavity; propagating microwaves into the microwave cavity, thereby obtaining another product; measuring a complex reflection coefficient of a microwave system comprising the microwave cavity and at least a microwave source; comparing the measured complex reflection coefficient to a target value for the complex reflection coefficient; and taking an action based on the comparison.

In one embodiment, the step of measuring the complex reflection coefficient is performed using one of a reflectometer and a network analyzer.

In one embodiment, the step of measuring the complex reflection coefficient is performed at an interface between the microwave cavity and the microwave source.

In one embodiment, the microwave system further comprises a coupler installed between the microwave source the microwave cavity, wherein said measuring the complex reflection coefficient is performed at an interface between the microwave cavity and the coupler.

In one embodiment, the method further comprises calculating at least one electromagnetic property based on the measured complex reflection coefficient, said comparing the measured complex reflection coefficient to the target value comprising comparing the at least one calculated electromagnetic property to a target value for the at least one electromagnetic property.

In one embodiment, the step of taking the action comprises triggering an alarm.

In one embodiment, the step of taking the action comprises determining a desired value for the control parameter based on the comparison and outputting the desired value.

In one embodiment, the step of determining a desired value for the control parameter is performed using a Smith plot.

In one embodiment, the step of outputting the desired value comprises adjusting the control parameter to the desired value.

In one embodiment, the method further comprises propagating the initial substance into a separator prior to said injecting the initial substance into the microwave cavity, thereby removing undesired product from the initial substance to obtain a separated substance.

In one embodiment, the step of propagating the initial substance into a separator comprises filtering the initial substance using a filter.

In one embodiment, the control parameter comprises a mesh size of the filter.

In one embodiment, the step of propagating the initial substance into a separator comprises propagating the initial substance into one of a desorption device and an adsorption device.

In one embodiment, the control parameter comprises one of a temperature of the separator and a flow rate for the initial substance passing through the separator.

In one embodiment, the method further comprises storing the separated substance into a storage tank, said injecting the initial substance into the microwave cavity comprising injecting the separated substance into the microwave cavity from the storage tank.

In one embodiment, the control parameter comprises a temperature of the storage tank.

In one embodiment, the method further comprises extruding the initial substance using an extruder.

In one embodiment, the control parameter comprises a temperature of the extruder.

In one embodiment, the method further comprises recirculating at least part of the desired product into one of the microwave cavity and a storage tank connected to the microwave cavity.

In one embodiment, the control parameter comprises a flow rate of the recirculated desired product.

In one embodiment, the method further comprises propagating the desired product into a centrifuge.

In one embodiment, the control parameter comprises one of a temperature, a bowl rotational speed and a differential speed for the centrifuge.

In one embodiment, the method further comprises propagating the desired product into a separator, thereby removing undesired product from the desired product to obtain a separated desired product.

In one embodiment, the step of propagating the desired product into a separator comprises filtering the desired product using a filter.

In one embodiment, the control parameter comprises a mesh size of the filter.

In one embodiment, the step of propagating the desired product into a separator comprises propagating the desired product into one of a desorption device and an adsorption device.

In one embodiment, the control parameter comprises one of a temperature of the separator and a flow rate for the desired product passing through the separator. In one embodiment, the method further comprises adding at least one of

microwave receptor particles and a catalyst into the microwave cavity.

In one embodiment, the control parameter comprises a quantity of said at least one of the microwave receptor particles and the catalyst.

In one embodiment, the control parameter comprises a flow rate of the initial substance injected into the microwave cavity.

According to a further broad aspect, there is provided a microwave system for performing a microwave-assisted treatment, the system comprising: a microwave cavity for receiving an initial substance; a microwave source of microwaves for propagating microwaves into the microwave cavity to perform the microwave-assisted treatment; a sensor for measuring a complex reflection coefficient of the microwave system; and a controller for comparing the measured complex reflection coefficient to a target value for the complex reflection coefficient and taking an action based on the comparison.

In one embodiment, the sensor comprises one of a reflectometer and a network analyzer.

In one embodiment, the sensor is positioned at an interface between the microwave cavity and the microwave source.

In one embodiment, the system comprises a coupler installed between the microwave source the microwave cavity, the sensor being positioned at an interface between the microwave cavity and the coupler.

In one embodiment, the controller is configured for calculating at least one electromagnetic property based on the measured complex reflection coefficient, said comparing the measured complex reflection coefficient to the target value comprising comparing the at least one calculated electromagnetic property to a target value for the at least one electromagnetic property.

In one embodiment, the controller is configured for triggering an alarm.

In one embodiment, the controller is configured for determining a desired value for the control parameter based on the comparison and outputting the desired value.

In one embodiment, the controller is configured for determining the desired value for the control parameter using a Smith plot.

In one embodiment, the controller is configured for adjusting the control parameter to the desired value.

In one embodiment, the system comprises a separator for removing undesired product from the initial substance to obtain a separated substance.

In one embodiment, the separator comprises a filter for filtering the initial substance.

In one embodiment, the control parameter comprises a mesh size of the filter.

In one embodiment, the separator comprises one of a desorption device and an adsorption device.

In one embodiment, the control parameter comprises one of a temperature of the separator and a flow rate for the initial substance passing through the separator.

In one embodiment, the system comprises a storage tank connected between the separator and the microwave cavity for storing the separated substance and injecting the separated substance into the microwave cavity.

In one embodiment, the control parameter comprises a temperature of the storage tank.

In one embodiment, the system comprises an extruder for extruding the initial substance.

In one embodiment, the control parameter comprises a temperature of the extruder.

In one embodiment, the system comprises a recirculation loop for recirculating at least part of the desired product into one of the microwave cavity and a storage tank connected to the microwave cavity.

In one embodiment, the control parameter comprises a flow rate of the recirculated desired product.

In one embodiment, the system comprises a centrifuge for receiving the desired product.

In one embodiment, the control parameter comprises one of a temperature, a bowl rotational speed and a differential speed for the centrifuge.

In one embodiment, the system comprises a separator for removing undesired product from the desired product to obtain a separated desired product.

In one embodiment, the separator comprises a filter for filtering the desired product.

In one embodiment, the control parameter comprises a mesh size of the filter.

In one embodiment, the separator comprises one of a desorption device and
an adsorption device.

In one embodiment, the control parameter comprises one of a temperature of the separator and a flow rate for the desired product passing through the separator.

In one embodiment, the system comprises a source of additive for injecting at least one of microwave receptor particles and a catalyst into the microwave cavity.

In one embodiment, the control parameter comprises a quantity of said at least one of the microwave receptor particles and the catalyst.

In one embodiment, the control parameter comprises a flow rate of the initial substance injected into the microwave cavity.

According to still another broad aspect, there is provided a method for detecting a failure in a microwave system comprising at least a microwave cavity and a microwave source during a microwave-assisted treatment of a mixture, the method comprising: measuring a complex reflection coefficient of a microwave system comprising the microwave cavity and at least a microwave source; comparing the measured complex reflection coefficient to predefined complex reflection coefficients each indicative of failure of the microwave system, thereby detecting the failure of the microwave system; and taking an action based on the comparison.

In one embodiment, the step of measuring the complex reflection coefficient is performed using one of a reflectometer and a network analyzer.

In one embodiment, the step of measuring the complex reflection coefficient is performed at an interface between the microwave cavity and the microwave source.

In one embodiment, the microwave system further comprises a coupler installed between the microwave source the microwave cavity, wherein the step of measuring the complex reflection coefficient is performed at an interface between the microwave cavity and the coupler.

In one embodiment, each predefined reflection coefficient is associated with a respective failure source, the step of comparing comprising identifying a given source for the failure.

In one embodiment, the step of taking an action comprises outputting an identification of the given source of failure.

In one embodiment, the step of taking an action comprises triggering an alarm.

In one embodiment, the step of taking an action comprises shutting down the microwave system.

According to still a further broad aspect, there is provided a system for detecting a failure in a microwave system comprising at least a microwave cavity and a microwave source during a microwave-assisted treatment of a mixture, the system comprising: a sensor for measuring a complex reflection coefficient of the microwave system; and a controller for: comparing the measured complex reflection coefficient to predefined complex reflection coefficients each indicative of failure of the microwave system, thereby detecting the failure of the microwave system; and taking an action based on the comparison.

In one embodiment, the sensor comprises one of a reflectometer and a network analyzer.

In one embodiment, the sensor is positioned at an interface between the microwave cavity and the microwave source.

In one embodiment, the microwave system further comprises a coupler installed between the microwave source the microwave cavity, the sensor being positioned at an interface between the microwave cavity and the coupler.

In one embodiment, each predefined reflection coefficient is associated with a respective failure source, the controller being further configured for identifying a given source for the failure.

In one embodiment, the controller is configured for outputting an identification of the given source of failure.

In one embodiment, the controller is configured for triggering an alarm.

In one embodiment, the controller is configured for shutting down the microwave system.

In the following, a microwave cavity should be understood as being a vessel made of a microwave-reflecting material having at least one opening for the injection of microwaves as well as other openings and/or ports for other purposes such as the connection of instruments, injection of material, exhaust of material, etc. A microwave reactor is an exemplary type of microwave cavities. Microwave cavities are generally made from highly conductive material (such as a metal) that reflects and contains the electromagnetic waves in the cavity. Microwave cavities can also contain solid objects or equipment that add boundaries inside the microwave cavity; mode stirrer, agitator, shaft, etc. Furthermore, the cavity walls and internal equipment bound an internal volume that can be either in vacuum or filled with a mixture that is single-phase or multi-phase; gas, liquid, solids or any homogeneous or heterogeneous mixture of one or several of those components. The control of the electromagnetic properties inside the microwave cavity is key for optimal operation of such devices. The electromagnetic properties inside the microwave cavity refer here to the effective electromagnetic properties resulting from all interactions of the electromagnetic waves in the cavity; interactions with the boundaries (their geometrical disposition and their properties) and the mixture inside the cavity

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1a is a block diagram illustrating an exemplary microwave system comprising a microwave cavity, in accordance with a first embodiment;

FIG. 1b is a block diagram illustrating an exemplary microwave system comprising a microwave cavity, in accordance with a second embodiment;

FIG. 2 is a block diagram illustrating an exemplary microwave system comprising a microwave cavity, in accordance with a third embodiment;

FIG. 3 is a block diagram illustrating an exemplary microwave system comprising a microwave cavity, in accordance with a fourth embodiment;

FIG. 4 is a block diagram illustrating an exemplary microwave system comprising a microwave cavity, in accordance with a fifth embodiment;

FIG. 5 is an exemplary Smith plot;

FIG. 6 is a block diagram illustrating an exemplary two-port microwave circuit.

FIG. 7 is a flow chart illustrating a method for controlling a microwave-assisted treatment, in accordance with a first embodiment;

FIG. 8 is a block diagram illustrating a microwave system for executing the method of FIG. 7, in accordance with an embodiment;

FIG. 9 is a flow chart illustrating a method for controlling a microwave-assisted treatment, in accordance with a second embodiment; and

FIG. 10 is a block diagram illustrating a microwave system for executing the method of FIG. 9, in accordance with an embodiment.

In the following, the term “substance” may refer to a single substance or to a mixture of substances. A substance may be a solid, a liquid, a gas, etc. or a combination of different phases.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

In the following there is described a method and system for controlling the electromagnetic properties inside a microwave cavity by monitoring conditions within the microwave cavity and taking an action upon the detection of a change in the microwave cavity conditions.

A microwave system generally consists of three main components: a microwave source, a microwave cavity and a transmission line between the source and the cavity. A microwave system usually requires a precise set of electromagnetic properties in order to provide a desired performance. If the set of electromagnetic properties of two of the above main components are known at all times (or are controlled within a known and well characterized range), then a change in the electromagnetic properties of the microwave system is the result of a change in the microwave system from the third component whose electromagnetic properties may be changing with time. For example, a microwave system may comprise of a microwave source and a transmission line whose electromagnetic properties are well characterized such that a change in the electromagnetic properties of the microwave system will be the result of a change in the electromagnetic properties of the microwave cavity.

It should be understood that the microwave system comprises a microwave cavity and all components required for generating the microwaves and propagating the generated microwaves into the microwave cavity, e.g., a microwave source and a transmission line. The microwave source comprises at least one microwave generator. The transmission line may comprise a microwave waveguide, a coupler for connecting the microwave waveguide to the microwave cavity, a tuner, etc.

The electromagnetic properties of the microwave system components are function of their characteristics, including the physical properties, the chemical properties and the geometrical properties of the materials constituting the microwave system, which include their temperature, pressure, density, chemical composition, geometrical disposition. In a dynamic microwave system where effective electromagnetic properties may change with time, the rate of change and time variation of the microwave system electromagnetic properties is also a function of the rate of change as well as the “change function” of those properties.

Since a microwave system usually requires a precise set of electromagnetic properties in order to provide a desired performance, the electromagnetic properties must be monitored over time and must be controlled in order to remain within a predetermined range. The monitoring of the electromagnetic properties may theoretically be done by monitoring all the physical, chemical and geometrical properties of the system. However, this is impossible, not easy and costly to perform in reality. For instance, a microwave system may comprise several components of which some may be moving and whose chemical composition and physical state may be changing over time. Furthermore, a microwave cavity may contain materials that undergo a microwave-assisted treatment. These materials may be a multiphase system consisting of solids, liquid and/or gas that are moving, interacting and undergoing chemical transformation over time. The properties cannot be known at all time because they may be changing over time in an unpredictable way.

A measurement that can be done and is function of the electromagnetic properties of the microwave system is the measurement of the complex reflection coefficient Γ which may be expressed as:

$$Γ = \frac{\frac{1}{{τ}_{e}} - \frac{1}{{τ}_{0}} - i Ω}{\frac{1}{{τ}_{e}} + \frac{1}{{τ}_{0}} + i Ω}$$

An ideal microwave system is characterized by 100% of microwave power transmitted from the microwave source to the microwave cavity (i.e., zero reflected power from the cavity to the source), in which case Γ=0. In reality, however, some reflected microwave power is always reflected from the cavity to the source. This reflected power can be determined by the electromagnetic properties of the microwave system.

The term 22 can be expressed as: Ω=ω−ω₀. The term w represents the angular frequency of the injected microwave, which is known (i.e., it can be measured), and the term ω₀ is the resonant frequency of the microwave system. The term Ω is a quantification of the offset between the excited microwave frequency (ω) from the resonance frequency (ω₀) of the cavity. The term Ω should be minimized to maximize the transmitted microwave power from the source to the cavity (or minimize the reflected microwave power from the cavity to the source) and maximise the system efficiency (or minimize the systems energy losses).

The terms τₑ and τ₀ are characteristic cavity lifetimes referring to the coupling component of the system and the load component of the system, respectively.

In an embodiment, a microwave system is operated with the term Ω being equal to zero or kept constant. This can be done with a stub tuner or an iris, for example. The reflection coefficient is then a function of τₑ and τ₀. The coupling term τₑ is a function of the electromagnetic properties of the cavity, while the load term τ₀ is a function of the electromagnetic properties of the load inside the microwave cavity.

In one embodiment, a microwave system is comprised of a microwave source, a transmission line and a cavity consisting of a slurry phase polystyrene depolymerization reactor. The coupling term the is a function of the properties of the cavity, including but not limited to the geometry of the interface between the waveguide and the reactor, the position of the interface between the waveguide and the reactor, the level of polystyrene melt inside the cavity, the mass fraction of contaminant inside the polystyrene melt, the electromagnetic properties of the contaminant inside the polystyrene melt, etc. On the other hand, the load term to is a function of the mass of the substance or mix of substance inside the microwave cavity, the mass of the microwave receptors, the geometry of the microwave receptors, the position of the microwave receptors inside the cavity. It should be noted that the microwave receptors can be fixed receptors located within the cavity or mobile inside the cavity, such as particles in suspension in the polystyrene melt inside the reactor or movable rods that may extend inside and outside of the cavity.

In one embodiment, a microwave system is comprised of a microwave source, a transmission line and a cavity consisting of a slurry phase polystyrene depolymerization reactor. The operating parameters are well characterized, monitored and/or controlled within a specific range to ensure good operation of the system. The reflection coefficient is also continuously measured and monitored. Since the complex reflection coefficient contains a real and an imaginary part, then two information are obtained from the measurement and this allows the determination of two parameters of the microwave cavity that affects its electromagnetic properties.

In one embodiment, the microwave treatment on a substance or a mix of substance inside the microwave cavity produces a side product/substance, contaminant or mixture of side products/substances or mixture of contaminants that may accumulate inside the microwave cavity. Then a change in the complex reflection coefficient can be due to the accumulation of a subproduct of the microwave treatment of the substance. In the case where the electromagnetic properties of the side product or mixture of side product is known, then the complex reflection coefficient can be used to calculate the fraction of the side product or mixture of side product inside the cavity. This is the first parameter determined from the complex reflection coefficient.

In another embodiment, the fraction of an element of known electromagnetic properties inside the microwave cavity can also be determined from the reflection coefficient. This is the second parameter determined from the complex reflection coefficient.

A microwave cavity usually requires a precise set of electromagnetic properties in order to provide a desired performance. Electromagnetic properties govern the rate at which a material will respond to absorption or emission of electromagnetic radiations such as microwaves. The method comprises two main steps: (1) monitoring of at least one electromagnetic property or parameter of the environment contained in the microwave cavity while microwaves are injected into the microwave cavity to characterize the conditions within the microwave cavity; and (2) taking an action based on the value of the monitored electromagnetic property to control the microwave cavity such as to maintain its operation as per predetermined parameters.

In one embodiment, at least one scattering parameter is monitored and used to determine the electromagnetic properties of the microwave cavity and calculate the chemical composition in the microwave cavity. One may assume that a generic chemical reaction occurring in the microwave cavity may be expressed as follows:

$$A + B + C \to B + C + D + E$$

where A is a substance; B is a contaminant present with the substance A; C is a microwave receptor, a catalyst or a mixture whose chemical composition remains unchanged during the chemical reaction; D is the desired product/substance; and E is an undesired product/substance.

Species A, B, C, D and E each have specific electromagnetic properties. Under normal operating conditions, the electromagnetic properties in the microwave cavity are within a predetermined range. The electromagnetic properties of microwave cavity are the result of a) the combination of the electromagnetic properties of the chemical components or mechanical elements present in the microwave cavity (such as rods, mixing device, etc.) and b) the electromagnetic properties of the cavity itself which depend on the geometrical arrangement of such components within the geometry, or microwave cavity. This implies that species A, B, C, D and E are each in predetermined ranges of concentration, dispersion in the cavity, phase (liquid, gas or solid), temperature and pressure. If the conditions of species A. B. C. D and/or E change, a change of the electromagnetic properties of the microwave cavity occurs. By measuring in real-time the electromagnetic properties of the microwave cavity, a change can be detected and a proper response can be triggered such as to bring back the process parameters in an acceptable or predetermined range.

In another embodiment, the complex reflection coefficient which is a scattering parameter is monitored and used to detect a malfunction or breakage of a component inside the microwave cavity. The scattering parameters arc function of the geometry and composition of the material that enters in contact with the microwaves. Therefore, any change in the geometry and/or composition due to a material or system failure in the microwave cavity will impact the value of the measured scattering parameters and an adequate response such as an alarm may be triggered. For example, if there is a radiofrequency (RF) window at the interface between the waveguide and the microwave cavity, the breakage of the RF window material changes the geometry (e.g., a crack is present) and composition (e.g., the crack is filled with the microwave cavity mixture).

In one embodiment, the electromagnetic properties that are relevant to the operation of a microwave cavity comprise the electric permittivity ε of the media, the electric conductivity σ and the permeability μ. It should be understood that the dielectric loss which may be represented by a loss angle δ or a loss tangent tan (δ) can be calculated using those parameters.

As known in the art, the electric permittivity ε represents a measure of the electric polarizability of a dielectric material. A material having a high permittivity ε polarizes more in response to an applied electric field than a material having a low permittivity ε, thereby storing more energy in the dielectric material. The permittivity ε is a complex number expressed by the following equation: ε=ε′−ε″j where ε′ is the real part of the permittivity ε and ε″ is the imaginary part of the permittivity E. The electric conductivity σ is a property of a material that quantifies how strongly it resists or conducts electric current. The permeability u is the measure of magnetization that a material obtains in response to an applied magnetic field. Finally, the dielectric loss quantifies the inherent dissipation of electromagnetic energy (e.g., heat) of a dielectric material. As mentioned above, the dielectric loss is usually represented by the loss angle δ or the loss tangent tan (δ) which both refer to the phasor in the complex plane whose real and imaginary parts are the resistive (lossy) component of an electromagnetic field and its reactive (lossless) counterpart. The loss tangent is given by: tan (δ)=ε″/ε′.

The present application covers reactive systems where the nature of the fluid inside the cavity may evolve over time. In the present application, the action of microwaves will initiate a physical or chemical transformation of one of the components initially present in the mixture. For example, the action of microwaves may initiate a change of phase of a specific component, like evaporation or precipitation of a certain component. In other cases, the action of the microwaves may also initiate a chemical decomposition of one of the components or initiate a catalytic combination of various components inside the mixture, or the production of various products that may all be the result of a combination of physical and chemical reactions. It then becomes obvious to the reader that such action of the microwaves on the fluid mixture inside the microwave cavity, by inducing a change in the composition of the mixture inside the microwave cavity may induce a change in electromagnetic properties of the fluid inside the microwave cavity. The present application covers cases where the electromagnetic properties of the fluid during the application of the microwave are changing and may require some controlling action to maintain the electromagnetic properties of the mixture stable over time.

More generally, the electromagnetic properties of the created mixture depend on the electromagnetic properties of the various components of the mixture (e.g., the electromagnetic properties of the initial mixture, the electromagnetic properties of contaminants, the electromagnetic properties of by-products created by the chemical reaction of the product within the reactor, etc.), as well as the proportion of the various components in the mixture. For example, physical characteristics (e.g., the geometry and/or the size) of the contaminants and/or the by-products, the phase of the contaminants and/or the by-products (e.g., solid, liquid or gaseous phase) and their dispersion (e.g., homogeneously dispersed within the mixture, heterogeneously dispersed within the mixture) can affect the electromagnetic properties of the mixture.

In one embodiment, contaminants comprise any chemical component that is not the desired substance or the desired product. For example, in a microwave polymer depolymerization process, a contaminant includes any material in the feedstock that is not the desired polymer such as another polymer, biomass material (e.g., paper, food), metal, carbon particles, fillers in the polymer, pigments in the polymer, etc. In a microwave polymer depolymerization process, contaminants may also include decomposition products from the feedstock(s) other than the targeted product(s) such as monomers, carbon, oligomers and/or other chemicals.

At least some microwave cavity systems may be represented as an RLC circuit. However, it is used as an analogy with the resistance (R) used as a general dissipation term. In at least some microwave cavity systems, it is desirable that the impedance Z of the microwave cavity matches that of the microwave source and circuit in order to maximize the transmitted microwave power and minimize the microwave reflected power. The impedance of a resonant microwave system is a function of the following elements:
the reactor cavity capacitance C which is a function only of the geometry of the reactor and the permittivity ε of the dielectric material inside the reactor. For many dielectric materials, the permittivity ε and thus the capacitance C are independent of the potential difference between the conductors and the total charge on them;
the reactor cavity inductance L which is defined as the ratio of the induced voltage to the rate of change of current causing it. It is a proportionality factor that depends on the geometry of the reactor and the magnetic permeability of material inside the reactor; and
the resistance R which is a function of the geometry of the reactor cavity and the loss tangent tan (δ) of the dielectric material inside the reactor. The resistance R is a key element of the heat transfer mechanism in microwave cavity. The impedance of a component on a microwave system is the result of its electromagnetic properties, which are the result of a) the combination of the electromagnetic properties of the chemical components or mechanical components present in the cavity and b) the geometrical arrangement of such components within the cavity.

In at least some embodiments, it is desired to control the electromagnetic properties of the substance mixture in a microwave cavity. If the composition of the mixture inside the microwave cavity changes and impacts its electromagnetic properties, the reactor impedance may change which will result in reducing the performance of the reactor by either:
reducing the amount of microwave power transmitted into the microwave cavity by creating an impedance mismatch between the microwave source and the microwave cavity; and/or
reducing the amount of energy transmitted to the reactive sites due to the presence of parasite contaminants that will also absorb energy, thereby reducing the overall performance of the microwave cavity.

The impedance mismatch between the microwave cavity and the microwave source can be characterized by the complex scattering or S parameter, or the complex reflection coefficient Γ, which both describe how much of a wave is reflected by an impedance discontinuity in a transmission medium. They are characterized by real and imaginary parts or magnitude and phase parts. It should be understood that the S parameter and the complex reflection coefficient Γ may interchangeably be used hereinafter.

While in the following, the method and system are described in the context of depolymerization including the depolymerization of thermoplastic polymers and thermosetting polymers, it will be understood that the present method and system can be used with any microwave cavity in which a microwave-assisted chemical reaction occurs, such as methane reforming, hydrogen production, biomass gasification and more. The present method and system also apply in the case there is no reaction in microwave cavity, but only a physical transformation (such as evaporation).

Changes in electromagnetic properties of a mixture contained within a microwave cavity may come from the material injected into the microwave cavity, i.e., the feedstock. For example, in the case of the use of a microwave cavity for depolymerization, polymers that are collected usually contain charges, additives and/or contaminants that interact with the electrical field in a microwave cavity. For example, some metals are resistive (i.e., they have a high dielectric loss) in a microwave cavity and absorb microwave energy to the detriment of the reactive sites. Copolymers may also change the permittivity of the mixture within the microwave cavity.

Changes in electromagnetic properties of a mixture contained within the microwave cavity may also come from the depolymerization itself that produces by-products such as carbon black that interact with the microwave field to cause interferences with the microwave field, thereby reducing the performance of the microwave cavity.

In the case of the depolymerization of a thermoplastic polymer, the removal of the contaminants can be performed when the polymer is molten so that solid contaminants can be more easily separated from the liquid polymer melt.

In the following, there is presented a method and system for pyrolyzing a product in a microwave cavity while controlling the electromagnetic properties of the mixture created into the microwave cavity in order to improve the impedance matching between the microwave source and the microwave cavity in order to improve the overall performance of the microwave cavity.

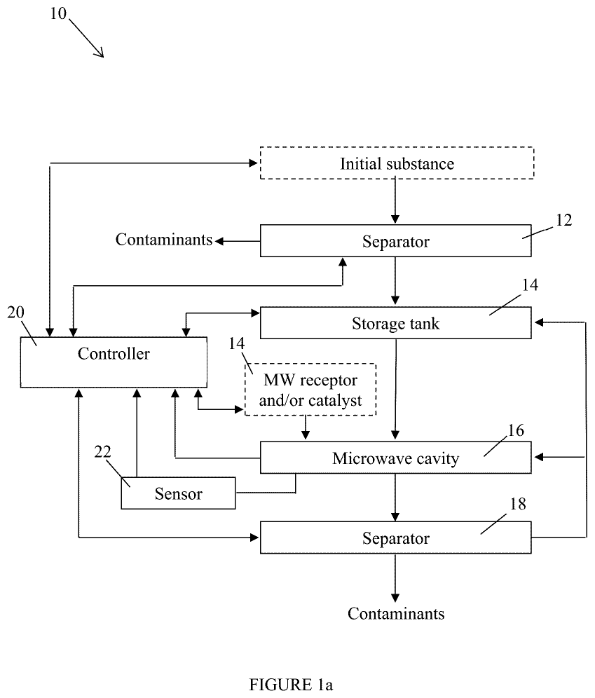

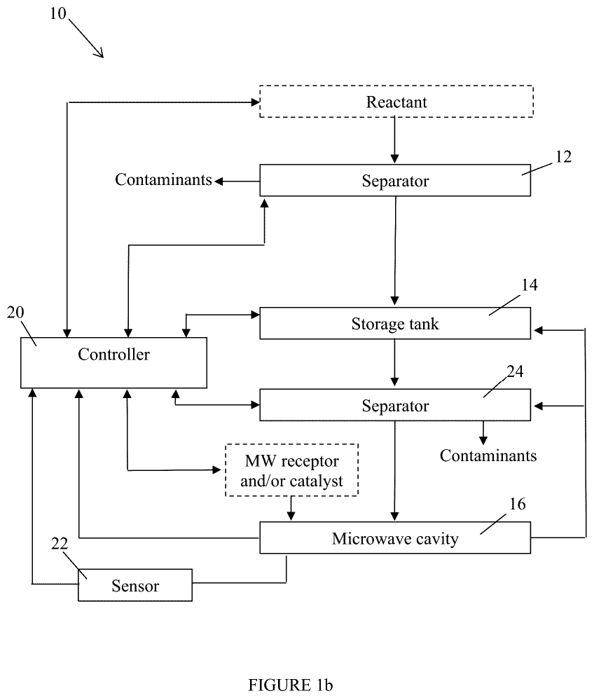

FIG. 1a illustrates one embodiment of a system 10 for performing a microwave-assisted chemical reaction of a substance. The system comprises a first separator 12, a storage tank 14, a microwave cavity 16, a microwave source (not shown), a microwave waveguide (not shown) for propagating the microwave generated by the microwave source to the microwave cavity 16, a second separator 18 and a controller 18. For example, the substance may be a product to pyrolyzed and may comprise at least some undesired products such as contaminants.

The initial substance is provided to the first separator 12 to obtain a separated substance. The first separator 12 separates at least partially the desired substance and undesired products such as contaminants. As a result of this separation step, the separated substance contains less undesired products than the initial substance, i.e., the substance received by the first separator 12.

It should be understood that a separator may be any adequate device adapted to separate at least two elements. For example, a separator may separate elements having different sizes, having different chemical compositions, being in different states/phases (such as liquid and gaseous states), and/or the like. For example, a separator may be a filter, s stripper, etc.

In one embodiment, the separator 12 comprises a filter adapted to remove from the initial substance insoluble particles having a specific size and electromagnetic properties impacting negatively the impedance of the microwave cavity. As a result, the filtrate, i.e. the separated substance, would contain less particles having a negative impact on the impedance of the microwave cavity.

In another example, a separator may be adapted to perform a desorption process that removes given dissolved gas having electromagnetic properties impacting negatively the impedance of the microwave cavity. As a result, the desorbed liquid would contain less of the given dissolved gas.

In a further example, a separator may be adapted to perform an adsorption process that would adsorb dissolved given contaminants having electromagnetic properties impacting negatively the impedance of the microwave cavity. As a result, the liquid from the adsorption unit would contain less of the given contaminants.

It should be understood that any combination of separation processes may also be viewed as a separation process in the sense of the present application.

In one embodiment, the separator 12 is omitted from the system 10. In this case the initial substance is directly provided to the storage tank 14.

The storage tank 14 is fluidly connected to the microwave cavity 16 and the purified substance from the separator 14 is stored into the storage tank 14 from which it can be injected into the microwave cavity 16. In one embodiment, a pump is connected to the fluidic connection between the storage tank 14 and the microwave cavity 16 to inject the separated substance stored into the storage tank 14 into microwave cavity 16.

The microwave cavity 16 is operatively connected to a source of microwaves (not shown) via a microwave waveguide (not shown) and an optional microwave coupler. In operation, microwaves generated by the source of microwaves are propagated into the microwave cavity 16 to induce a chemical reaction of the substance into the microwave cavity 16, such as to pyrolyze the separated substance injected into the microwave cavity 16. The separated substance interacts with microwaves propagating into the microwave cavity 16 to create a mixture that comprises a desired product and also undesired products such as by-products and contaminants.

In one embodiment, microwave receptors and/or a catalyst is injected into the microwave cavity 16 in order to trigger a chemical reaction and/or enhance a chemical reaction. In this case, the system 10 further comprises a source of microwave receptors and/or catalyst fluidly connected to the microwave cavity 16.

The system 10 further comprises a fluidic connection that connects an exit of the microwave cavity 16 to an input of the second separator 18. A further fluidic connection connects the output of the second separator 18 to an input of the microwave cavity 16 and/or an input of the storage tank 14 to create a recirculation loop. When the system 10 is in operation, some of the mixture contained within the microwave cavity 16 is extracted from the microwave cavity 16 and propagated up to the input of the second separator 18. The second separator 18 is configured for removing at least some of the undesired products present in the extracted mixture. At least some of the thus-obtained purified mixture is recirculated into the microwave cavity 16 either directly and/or indirectly via the storage tank 14.

It should be understood that fluidic connections such as pipes or ducts fluidly connect the first separator 12, the storage tank 14, the microwave cavity 16 and the second separator 18. For example, at least one pipe may fluidly connect together the first separator 12 and the storage tank 14. As mentioned above, a pump may be connected to the pipe to create a flow of purified product from the first separator 12 to the storage tank 14. At least one second pipe may fluidly connect together the storage tank 14 and the microwave cavity 16. A further pump may be connected to the second pipe so extract some of the separated product contained into the storage tank 14 and inject it into the microwave cavity 16. At least one third pipe may fluidly connect the microwave cavity 16 and the second separator 18 together. Another pump may be connected to the third pipe to extract some of the mixture contained within the microwave cavity 16 to be separated by the second separator 18. At least one fourth pipe may fluidly connect the second separator 18 and the storage tank 14 and/or the microwave cavity 16 to recirculate the separated mixture into the microwave cavity 16 either directly or indirectly.

In one embodiment, at least some of the fluidic connections contained in the system 10 may be heated to maintain the product flowing therein at a desired temperature. For example, a least one heating device may be operatively connected to the pipe connecting the first separator 12 and the storage tank 14. It will be understood that the heating device may be integrated into the pipe.

In one embodiment, the system 10 comprises valves for controlling the flow rates of the different products propagating between the different components of the system 10. In the same or another embodiment, the speed of a pump may be varied in order to vary the flow rate of a product.

Referring back to FIG. 1a, the system 10 further comprises the controller 20 and a sensor 22 in communication with the controller 20. The controller 20 controls the operation of at least some of the other components of the system 10 so as to control the amount of undesired products present in the mixture created in the microwave cavity 16 and thereby control the electromagnetic properties of the mixture contained into the microwave cavity 16.

The sensor 22 is configured for measuring the complex reflection coefficient Γ of the system comprising the microwave cavity 16, the waveguide and the microwave source. In one embodiment, the sensor 22 is configured for measuring the scattering parameter matrix (S-parameter matrix) and the complex reflection coefficient Γ is obtained from the S-parameter since the complex reflection coefficient Γ corresponds to the coefficient S₁₁ of the S-parameter matrix.

In one embodiment, the sensor 22 comprises a reflectometer or a network analyzer. However, it should be understood that any adequate method and/or system adapted to determine or measure the complex reflection coefficient Γ can be used.

In one embodiment, the sensor 22 is positioned so as to measure the complex reflection coefficient Γ at the interface between the microwave cavity 16 and the microwave source, if no waveguide is present between the microwave cavity 16 and the microwave source, or at the interface between the microwave cavity 16 and the microwave waveguide used for propagating the microwaves from the microwave source to the microwave cavity 16.

The controller 20 is further configured for determining the value of at least one control parameter based on the measured complex reflection coefficient Γ, the determined value of the control parameter being chosen based on a desired value for the electromagnetic property, as further described below. The control parameter(s) may be an operating parameter of the first separator 12, a parameter of the storage tank 14, a parameter of the second separator 18 or a flow rate of at least one product propagating between two components of the system 10, as described in greater detail below. The controller 20 is further configured for adjusting the control parameter to the determined value so as to modify the amount or proportion of undesired products contained in the mixture and thereby adjust the electromagnetic property of the mixture to a desired value.

It should be understood that a control parameter for the separator 12 and separator 18 may differ depending on the type of separator involved. For example, if the separator 12, 18 is a filter, a typical control parameter might be the mesh size of the filter. If the separator is an adsorption/desorption unit, the control parameter might involve residence time in the separator as well as temperature inside the separator. If the separator is a degassing unit, the controlling parameters might involve the operating pressure and temperature. It should be understood that the control parameter may be any adequate parameter that provides a control gain between the manipulated control parameter and the measured electromagnetic properties of the output from the separator 12, 18.

An example of control parameter for the storage tank 14 may include the temperature of the storage tank 14. It should be understood that the controlling parameter may be any adequate parameter that provides a control gain between the manipulated controlling parameter and the measured electromagnetic property of the output from the tank 14.

In one embodiment, since the complex reflection coefficient Γ of the system comprising the microwave cavity 16, the waveguide and the microwave source is representative of the electromagnetic properties inside the microwave cavity 16, the output of the controller 20 manipulates the control parameters identified above directly based on the measured complex reflection coefficient Γ obtained from sensor 22 of the system comprising the microwave cavity 16, the waveguide and the microwave source.

In this case, the input of the controller 20 is the measured complex reflection coefficient T obtained from sensor 22. The controller 20 then compares the determined or measured reflection coefficient Γ to a predefined or target reflection coefficient Γ. The output of the controller 20 then is a new value for the control parameters directly based on the comparison between the determined or measured complex reflection coefficient Γ and the predefined or target complex reflection coefficient Γ.

In an embodiment, in which the controller 20 is configured for controlling a control parameter directly based on the complex reflection coefficient Γ, the controller 20 comprises a database of possible media that can be contained in the microwave cavity 16 and a respective value for the complex reflection coefficient. In this case, a user may input a desired mixture and the controller retrieves the corresponding value for the complex reflection coefficient Γ which is used as the target value.

In an embodiment in which the controller 20 is configured for determining an electromagnetic property inside the microwave cavity 16, the value of the complex reflection coefficient Γ is used to evaluate the electromagnetic property inside the reactor cavity via a transfer function. The transfer function is defined using a model that describes the relationship between the electromagnetic properties inside the reactor cavity and the complex reflection coefficient Γ. Different types of models can be used. For example, Maxwell's equations can be solved using a finite element method inside the reactor cavity, and the waveguide and microwave source can be modeled. The exact geometries of the cavity and the waveguide are inputted into the model. The material and their physical, chemical and electromagnetic properties that make up the reactor cavity walls, waveguide walls, the interface between the waveguide and the reactor cavity as well as the material filling the waveguide are known and inputted into the model (e.g., nitrogen or air). The only unknown elements comprise the electromagnetic, (dielectric, electric and magnetic) properties in the reactor cavity. Therefore, the model allows for calculating the relationship between the reflection coefficient Γ of the system and the electromagnetic properties inside the reactor cavity. The chemical composition, mass fraction, shape and distribution of contaminants present in the mixture in the material filling the reactor cavity affects the electromagnetic properties inside the microwave cavity. The relationship between the contaminant properties and the electromagnetic properties can be determined via an electromagnetic mixing model and/or empirical measurements.

In another embodiment, an equivalent circuit or RLC model is used. The microwave system is modeled as an electrical circuit where each component has a contribution of either resistance, inductance, capacitance or a combination of these. The chemical composition, mass fraction, shape and distribution of contaminants present in the mixture in the material filling the reactor cavity affects the electromagnetic properties inside the microwave cavity and therefore affects its contribution to the circuit in terms of resistance (R), inductance (L) and capacitance (C). The relationship between the contaminant properties and the RLC contribution can be determined via an electromagnetic mixing model and/or empirical measurements.

In a further embodiment, the controller 20 comprises a database of different possible mixtures that may be contained in the microwave cavity 16 and a respective value for the electromagnetic property of the mixture. In this case, the user may input a desired mixture and the controller 20 is configured for retrieving the value of the electromagnetic property that corresponds to the selected mixture, the retrieved value corresponding to the target value for the electromagnetic property.

In one embodiment, a change in the value of the complex reflection coefficient indicates a change in the reactor impedance and therefore a change in the effective permittivity ε of the mixture contained within the microwave cavity 16. Also, the change in the effective permittivity ε may indicate an accumulation or a presence of an undesired product inside the reactor 16.

In one embodiment, the above-described method may also be used for detecting operation issues such as loss of mixing if the microwave absorbers are no longer in suspension in the mixture or the breakage of a component such an agitator or a RF window.

In one embodiment, the correlation between the values of the complex reflection coefficient Γ and the values of the electromagnetic properties such as the real part ε′ and the imaginary part ε″ of the effective permittivity ε is determined based on experiments. In this case, for a given mixture comprising a given type of undesired products in a given amount or proportion and for a given microwave cavity 12 and a given microwave power delivered to the microwave cavity 12, the complex reflection coefficient Γ is measured while the real part ε′ and the imaginary part ε″ of the effective permittivity ε are measured from a sample of the mixture contained in the microwave cavity 16. The parameters such as the type of undesired products, their proportion within the initial substance, the microwave power, etc. can be varied and the complex reflection coefficient and the real part ε′ and the imaginary part ε″ of the effective permittivity ε are measured so as to obtain a correlation between the values of the complex reflection coefficient and the values of the real part ε′ and the imaginary part ε″ of the effective permittivity ε for different parameter values such as different values of microwave power injected into the microwave cavity 16.

In another embodiment and as mentioned above, the electromagnetic properties inside the microwave cavity are calculated based on the measured complex reflection coefficient Γ and Maxwells' equations as follows. The method to calculate the electromagnetic properties inside the cavity is based on a finite element method to solve for the electromagnetic fields within the modeling domains composed of the waveguide and reactor cavity. Under the assumption that the system is in steady state, i.e., the fields vary sinusoidally in time at a known angular frequency and that all material properties are independent with respect to electric and magnetic field strength, the governing Maxwell's equations in three dimensions may be expressed as follows:

$$∇ \times {μ}_{r}^{- 1} ( ∇ \times E ) - \frac{{ω}^{2}}{{c}_{0}^{2}} ( {ε}_{r} - \frac{j σ}{ω {ε}_{r}} ) E = 0$$

where εᵣ is the relative permittivity. μᵣ is the relative permeability, σ is the electrical conductivity. E is the electrical field vector, w is the angular frequency and c₀² is the speed of light in vacuum.

The above equation is known as the wave equation of the electric field. The parameters that are dependent on the properties inside the modeling domain is the relative permittivity εᵣ, the relative permeability μᵣ and the electrical conductivity σ. The electrical field E vector is solved in the entire domain and the scalar complex scattering parameters are derived from the calculated electrical field pattern. It may be noted that the electrical field can be solved using numerical methods such as finite element methods, finite difference methods or modal analysis. Domain decomposition can also be used to solve certain regions of simple geometry using modal analysis and the regions of more complex geometry using finite element or finite difference methods.

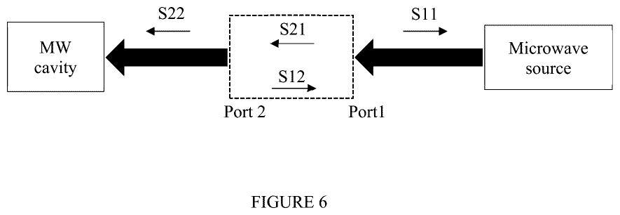

In one embodiment and referring to FIG. 6, the system corresponds to a two-port microwave circuit with a microwave source injecting microwaves at port 1 and the microwaves being transmitted through port 2 to the microwave cavity 16. The impedance mismatch along the circuit reflects microwaves back to the source such that there are incident and reflected microwaves between the source and port 1 as well as between port 2 and the microwave cavity 16. The scattering parameters (or S-parameters) can be used to quantify how the microwave energy propagates through the two-port microwave circuit. For a 2-port microwave circuit, there are four S-parameters S₁₁, S₁₂, S₂₁ and S₂₂. Parameter S₁₁ is the input port voltage reflection coefficient, parameter S₁₂ is the reverse voltage gain, parameter S₂₁ is the forward voltage gain and parameter S₂₂ is the output port voltage reflection coefficient. The person skilled in the art will understand that the expressions “electric field” and “voltage” may be used interchangeably in the present case.

To convert an electric field pattern on a port to a scalar complex number corresponding to the voltage in transmission line theory, an eigenmode expansion of the electromagnetic fields on the ports is performed. It is assumed that an eigenmode analysis has been performed on the ports 1 and 2 and that the electric field patterns E₁ and E₂ of the fundamental modes on these ports are known. Further, it is also assumed that the fields are normalized with respect to the integral of the power flow across each port cross section, respectively. This normalization is frequency dependent unless TEM modes are being dealt with. The port excitation is applied using the fundamental eigenmode, i.e., the mode with subscript 1. The computed electric field E_{c} on the port consists of the excitation plus the reflected field. That is, on the port boundary where there is an incident wave, the computed field can be expanded in terms of the mode fields as follows:

$${E}_{c} = {E}_{1} + {\sum }_{i = 1} {S}_{i 1} {E}_{i}$$

Whereas on all other port boundaries, the computed field is given by the following equation:

$${E}_{c} = {\sum }_{i = 1} {S}_{i 1} {E}_{i}$$

The S-parameter for the mode with index k is then given by multiplying with the conjugate of the mode field for mode k and integrating over the port boundary. Since the mode fields for the different modes are orthogonal, the following relations are obtained for the S-parameters:

$${S}_{11} = \frac{{\int }_{port 1} ( ( {E}_{c} - {E}_{1} ) {E}_{i}^{*} ) d {A}_{1}}{{\int }_{port 1} \begin{matrix}( {E}_{1} & {E}_{1}^{*} ) d {A}_{1}\end{matrix}}$$

The reflection coefficient Γ₁=S₁₁ since the response is a wave traveling out of the reactor in the same port as the stimulus (reflected wave).

Table 1 provides the electromagnetic property values for some materials at a given wavelength that can be a substance, a contaminant, a by-product, etc.

TABLE 1
Typical permittivity, permeability and electrical
conductivity of materials at a given wavelength.

| | Permittivity | | Relative | Conductivity |
|---|---|---|---|---|
| Material | ε′ | ε″ | permeability | (S/m) |
| Polystyrene | 2.31 | 0.000 | 1 | 0 |
| Carbon black | 2.5-3.0 | 0.04-0.35 | 1 | 0 |
| Polyethylene | 2.2 | 0.002 | 1 | 0 |
| Polypropylene | 2.2 | 0.002 | 1 | 0 |
| PET | 3 | 0.002 | 1 | 0 |
| Nylon | 3.4 | 0.2 | 1 | 0 |
| ABS | 1.4-3.1 | 80-90 | 1 | 0 |
| Silicon carbide | 21.8 | 3.673 | 1 | 0 |
| PVC | 2.7-3.1 | 0.025 | 1 | 0 |
| Alumina oxide 99.5% (Al2O3) | 9.88 | 0.001 | 1 | 0 |
| Silicon nitride (Si3N4) | 7.74-8.71 | 0.002-0.014 | 1 | 0 |
| Titanium dioxide (TiO2) | 90 | 0.009 | 1 | 0 |
| Distilled water | 77.45 | 12 | 1 | 0 |
| Zirconia (ZrO2) | 15.09 | 0.025 | 1 | 0 |
| Fused silica (SiO2) | 3.77 | 0.000377 | 1 | 0 |
| Fir wood (0% moisture) | 2.5 | 0.09 | 1 | 0 |
| Sand (4% moisture) | 3.33 | 0.13 | 1 | 0 |
| Clay (4% moisture) | 3.05 | 0.78 | 1 | 0 |
| Ethylene Glycol | 12 | 12 | 1 | 0 |

Table 2 provides the value of the electromagnetic properties of some mixtures of polystyrene comprising microwave absorbers, sand and/or carbon and the respective S₁₁ parameter at the interface between the microwave cavity and the waveguide at a given wavelength λ based on a volumetric mixing law. It should be understood, that another mixing law have also be used to calculate an electromagnetic property of a mixture of substances.

TABLE 2
Electromagnetic properties of the mixtures and corresponding
S₁₁ parameter value at a given wavelength.

| | Permittivity | | | | |
|---|---|---|---|---|---|
| | Dielectric | Loss | | Electrical | |
| | constant | factor | Relative | conductivity | S₁₁ |
| Material | (ε′) | (ε″) | permeability | (S/m) | parameter |
| Baseline | 2.50 | 0.01 | 1 | 0 | 0.1427 − |
| (Polystyrene | | | | | 0.2001i |
| with MW | | | | | |
| absorbers) | | | | | |
| Baseline + 1 | 2.51 | 0.0134 | 1 | 0 | 0.0417 + |
| vol % carbon | | | | | 0.1447i |
| Baseline + 2 | 2.51 | 0.0168 | 1 | 0 | 0.1253 + |
| vol % carbon | | | | | 0.1494i |
| Baseline + 3 | 2.51 | 0.0202 | 1 | 0 | 0.2252 + |
| vol % carbon | | | | | 0.2852i |
| Baseline + 4 | 2.52 | 0.0236 | 1 | 0 | 0.2546 + |
| vol % carbon | | | | | 0.2620i |
| Baseline + 5 | 2.53 | 0.0270 | 1 | 0 | 0.3031 + |
| vol % carbon | | | | | 0.2738i |
| Baseline | 2.405 | 0.006 | 1 | 0 | 0.6843 − |
| less 50% MW | | | | | 0.1305i |
| absorbers | | | | | |
| Baseline | 2.31 | 0.002 | 1 | 0 | −0.3190 + |
| without MW | | | | | 0.6890i |
| absorbers | | | | | |
| Baseline | 2.5083 | 0.0112 | 1 | 0 | −0.0242 + |
| with 1 vol % | | | | | 0.0801i |
| sand | | | | | |
| Baseline | 2.5166 | 00124 | 1 | 0 | 0.0727 + |
| with 2 vol % | | | | | 0.3298i |
| sand | | | | | |

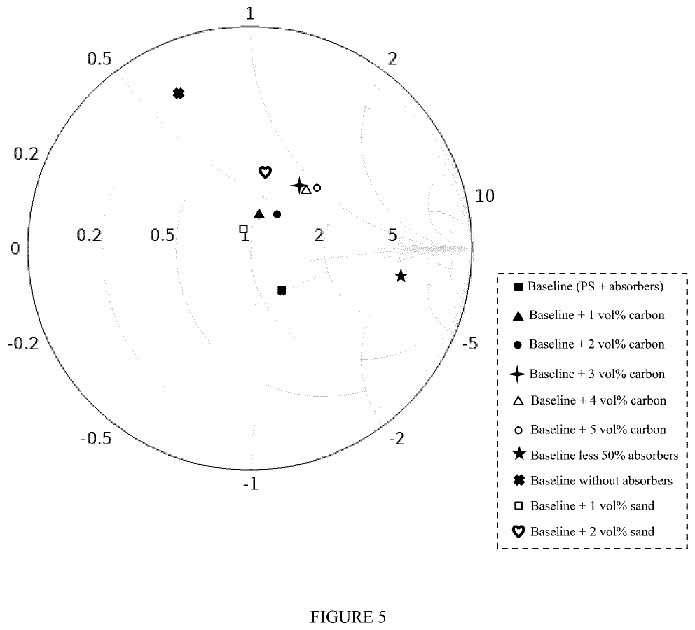

FIG. 5 represents a Smith plot of the complex reflection coefficient S₁₁ for the different mixtures of Table 2. For a given set of cavity mixture properties (permittivity, permeability and electrical conductivity), the S-parameter matrix is obtained empirically for example. FIG. 5 is an exemplary Smith plot of S₁₁ parameter for a cavity that contains polystyrene with microwave absorbers (baseline during normal operation) and a given percentage of carbon. If there is an accumulation of carbon particles in the cavity, the value of the Sun parameter changes and this corresponds to a specific set of cavity mixture properties as described in Table 2. From the calculated properties, the controller 20 may determine that an accumulation of contaminant occurs in the mixture contained in the microwave cavity and may also determine the type of contaminant and its loading by mapping the effect of various contaminants loading on the Sn parameter and by knowing which ones are most probable depending on the application. This may be seen similar to a FT-IR measurement where reference spectra of specific chemical species that are susceptible of being present are loaded and the concentration of each species that gives the best fit with the measured IR absorbance spectrum is calculated. FIG. 5 also shows the case where the microwave absorber particles are no longer present in the cavity. Therefore, this method may provide more operational problem insights than just accumulation of contamination.

The profile of the change in the S11 parameter is a function of the effective electromagnetic properties inside the cavity, which is a function of the type of contaminants inside the cavity and the fraction of the contaminant inside the microwave cavity. Therefore, the profile of the change in the S11 parameter allows the determination of the type of contaminant inside the microwave cavity and its fraction (mass fraction or volume fraction) inside the microwave cavity. The rate of change in the S11 parameter determines the rate of change of the fraction (mass fraction or volume fraction) inside the microwave cavity.

It should be understood that the Smith plot can be used for determining the specific problem that occurs since the position of the value of the S₁₁ parameter within the Smith plot is indicative of the problem. Referring to Table 2, the baseline value of S₁₁ parameter, i.e., the target value under normal operation, is 0.1427-0.2001i. If the value of the S₁₁ parameter changes to 0.0417+0.1447i, then it is determined that carbon is present into the mixture since the new value for the Sun parameter corresponds to the baseline+1 vol % carbon. In another example, if the value for the Sun parameter changes to 0.0727+0.3298i, it is determined that sand is present in the mixture since the new value for the S₁₁ parameter corresponds to baseline with 2 vol % sand. The person skilled in the art will understand that the same applies when the value of an electromagnetic property is calculated based on the value of the S₁₁ parameter.

In one embodiment, when it detects that the electromagnetic property value or the value of the measured reflection coefficient Γ does not correspond to the target value, the controller 20 may triggers an alarm. For example, when the permittivity ε has decreased (which is indicative of the presence of undesired products or the increase of the amount or proportion of undesired products), the controller 20 triggers an alarm to indicate that the system 10 does not properly operate or that a problem has been detected. For example, the problem may be a malfunction of the separator 12, 18 or the recirculation loop. In another example, the problem may be indicative that the parameters of a separators 12, 18 may no longer be adequate that the separator parameters 12, 18 must be changed to a different parameter by the controller 20.

In another embodiment, upon detection of a variation of the value of the measured reflection coefficient Γ or the determined value of the electromagnetic property has changed relative to the target value, the control 20 may adjust a control parameter to bring back the value of the measured reflection coefficient Γ or determined electromagnetic property to the target value. For example, upon detection of a decrease of the dielectric permittivity ε, the controller 20 determines the value of a control parameter to be adjusted to compensate for the decrease of the dielectric permittivity ¿.

In one embodiment, upon detection of a variation of the measured reflection coefficient Γ or the determined electromagnetic property value, the controller 20 may take at least one of the following actions:
Increase or decrease the control parameter of the separator 12, such as the increase or decrease of the mesh size when the separator 12 is a filter;
Increase or decrease the control parameter of the separator 18, such as the increase or decrease of the mesh size when the separator 18 is a filter;
Increase or decrease the flow rate of initial product passing through the first separator 12;
Increase or decrease the temperature of the first separator 12 and/or the storage tank 14;
Increase or decrease the temperature of the second separator 18;
Increase or decrease the flow rate of mixture recirculated into the microwave cavity 16 or the storage tank 14;
Increase or decrease the temperature of an extruder, when present;
Increase or decrease of the temperature, the bowl rotational speed and/or the differential speed of a centrifuge 110, when present;
Addition of microwave receptor particles and/or a catalyst;
Movement of a microwave receptor and/or addition or removal of a microwave receptor;
Increase or decrease of the flow rate of substance injected into the microwave cavity 16; and/or
Trigger of an alarm.

For example, when a decrease in the effective dielectric permittivity is detected, the value of the Sn parameter or that of the electromagnetic property is indicative of the problem that is occurring and a corrective action can be performed accordingly.

If the value of the effective dielectric permittivity is indicative of a contaminant such as particulate solids containing carbon is created by the chemical reaction in the microwave cavity 16 and therefore present in the mixture, the controller may increase the recirculation flow rate, decrease the mesh size of the separator 18 and/or lower the temperature of the storage tank 14, the separator 12 and/or 18 and/or the extruder.

If the value of the effective dielectric permittivity is indicative of a contaminant that comes from the substance (e.g., sand) is present in the mixture, the controller may decrease the mesh size of the separator 12 if the mesh size of the separator 12 is adjustable or triggers an alarm indicative that the mesh size of the separator 12 has to be decreased so that the separator 12 may be replaced.

If the value of the effective dielectric permittivity is indicative of a decrease in the number of microwave receptor particles present in the microwave cavity 16, the controller 20 may inject additional microwave receptor particles into the microwave cavity 16.

If the value of the effective dielectric permittivity is indicative of a decrease in the level of mixture into the microwave cavity 16, the controller 20 may increase the feed rate of substance into the microwave cavity 16.

If the value of the effective dielectric permittivity is indicative of a system failure (e.g., a microwave coupler breakage), the controller 20 may trigger an alarm.

In one embodiment, the amplitude of the corrective action (e.g. increase or decrease amplitude of a temperature) performed by the controller 20 is based on the amplitude of the variation of the dielectric permittivity or the S₁₁ parameter. For example, the amplitude of the corrective action may be determined empirically. In this case, for each possible corrective action, a database may comprise a corrective action amplitude for each possible variation of effective dielectric permittivity or the S₁₁ parameter. The controller 20 then accesses the database to determine the amplitude for the corrective action based on the variation of effective dielectric permittivity or the S₁₁ parameter.

In another embodiment, the controller 20 may apply a feedback loop to determine the amplitude variation to be applied. In this case, the controller 20 adjusts gradually the amplitude variation of the control parameter to perform gradually the corrective action. The controller stops varying the amplitude of the control parameter when the value of the effective dielectric permittivity or the S₁₁ parameter reaches the target value. For example, if the effective dielectric permittivity is indicative of a decrease in the level of mixture into the microwave cavity 16, the controller 20 may gradually increase the feed rate of substance into the microwave cavity 16 until the value of the effective dielectric permittivity reaches the target value.

Referring back to FIG. 1a, the person skilled in the art will understand that the system 10 may be modified. For example, the separator 12 may be omitted. In one example and as illustrated in FIG. 1b, the system 10 may comprise a separator 24 located between the storage tank 14 and the microwave cavity 16 and control parameters of the separator such as its temperature may be controlled by the controller 20. Such a separator 24 between the storage tank 14 and the microwave cavity 16 may be useful when an agglomeration, aggregation or filtration agent is added in the storage tank 14. The storage tank 14 is then used as a mix tank for mixing together the agent and the substance melt and providing them with sufficient residence time for the mixing and interaction to occur. Referring back to FIG. 1b, the system 10 comprises no separator 18 and the product generated in the microwave cavity 16 are recirculated in the storage tank 14 or the separator 24 without being processed by the separator.

In an embodiment in which the substance comprises large contaminants, the separator 12 is configured to remove the large contaminants from the substance to prevent any pump located between the storage tank 14 and the separator 12 to be blocked. For example, the separator 12 may be configured to remove large contaminants such as labels when the substance is a polymer feedstock.

It should be understood that any adequate separator may be used in the system 10. For example, the separator 12 can apply different sorting steps of a polymer sorting line such as manual sorting, screen, electromagnets to remove magnetic contaminants, flotation, magnetic separation, optical sorting, etc. If it is a thermoplastic, the substance can be injected in the storage tank in solid form where it will melt or using an extruder with a melt filter to inject in the storage tank.

In one embodiment, the product provided to the first separator 12 is melted before reaching the first separator 12. In one embodiment, the temperature of the product before reaching the first separator 12 is chosen so that the desired product to be pyrolyzed be melted while at least some of the undesired products remain in a solid phase.

The first separator 12 is fluidly connected to the storage tank 14 and the separated product is then provided to the storage tank 14 to be stored therein. In one embodiment, a pump may be present and connected to the fluidic connection between the first separator 12 and the storage tank 14 to propagate the separated product into the storage tank 14.

The storage tank 14 is designed so as to store the separated product and is provided with a heating device so as at least to maintain the separated product contained therein at a target temperature.

In an embodiment in which the initial product provided to the first separator 12 is melted, the heating device of the storage tank 14 is configured for maintaining the separated melted product at a desired temperature.

In an embodiment in which the initial product provided to the first separator 12 is a solid product, the heating device of the storage tank 14 is configured for melting the separated product received from the first separator 12 and maintaining the separated melted product at a desired temperature.

In an embodiment in which the second separator 24 is present between the storage tank 14 and the microwave cavity 16, an agglomerating agent may be injected into the storage tank 14 to agglomerate contaminants having a small particle size. The agglomerated contaminant particles may then be separated by the separator 24.

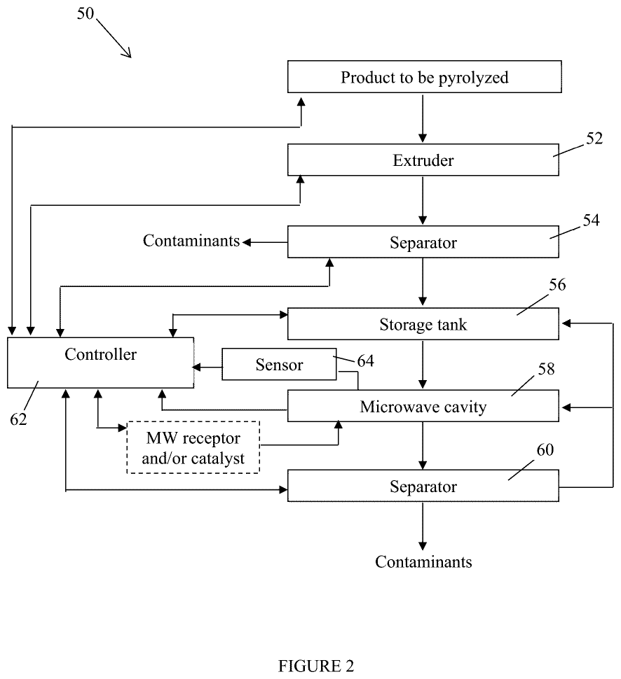

FIG. 2 illustrates one embodiment of a system 50 for performing the pyrolysis of a thermoplastic polymer. The system 50 comprises a source of product to be pyrolyzed. i.e., a source of thermoplastic polymer, an extruder 52, a first separator 54, a storage tank 56, a microwave cavity 58, a second separator 60, a controller 62 and a sensor 64.

The extruder 52 is connected to the source of thermoplastic polymer to receive thermoplastic polymer therefrom and melt the received thermoplastic polymer. The melted thermoplastic polymer is then separated by the first separator 54 before being stored into the storage tank 56. Some melted thermoplastic polymer is then fed into the microwave cavity 58 and microwaves generated by a microwave source (not shown) and propagated by a microwave waveguide (not shown) are propagated into the microwave cavity 58 to pyrolyze the thermoplastic polymer. The pyrolysis product exits the microwave cavity 58 and is separated by the second separator 60 to remove contaminants present in the pyrolysis product. At least some of the separated product is reinjected into the storage tank 56 and/or the microwave cavity 58.

It should be understood that pumps are also present to propagate the different product between components of the system 50.

Similarly to the controller 20 of system 10, the controller 62 controls operation or control parameters of the other elements of the system 50. For example, the controller 62 may control the temperature of the extruder 52, the first and/or second separator 54 and/or the storage tank 56, flow rates of products such as the flow rate of melted thermoplastic polymer injected into the microwave cavity 58 from the storage tank 56 or the flow rate of pyrolyzed product reinjected into the storage tank 56 and/or the microwave cavity 58, the flow rate of microwave receptor and/or catalyst injected into the microwave cavity form a source of microwave receptor and/or catalyst, etc.

Similarly to sensor 22, the sensor 64 is adapted to measure the complex reflection coefficient Γ of the system comprising the cavity of the microwave cavity 58, the waveguide and the microwave source.

Similarly to controller 22, the controller 62 is configured for controlling at least one control parameter of at least one component of the system 50 and/or triggering an alarm based on the measured value for the complex reflection coefficient, as described above. In one embodiment, the controller 62 is further configured for calculating a electromagnetic property of the mixture contained in the microwave cavity 58 such as the dielectric permittivity of the mixture and controlling at least one control parameter and/or triggering an alarm based on the calculated value of the electromagnetic property.

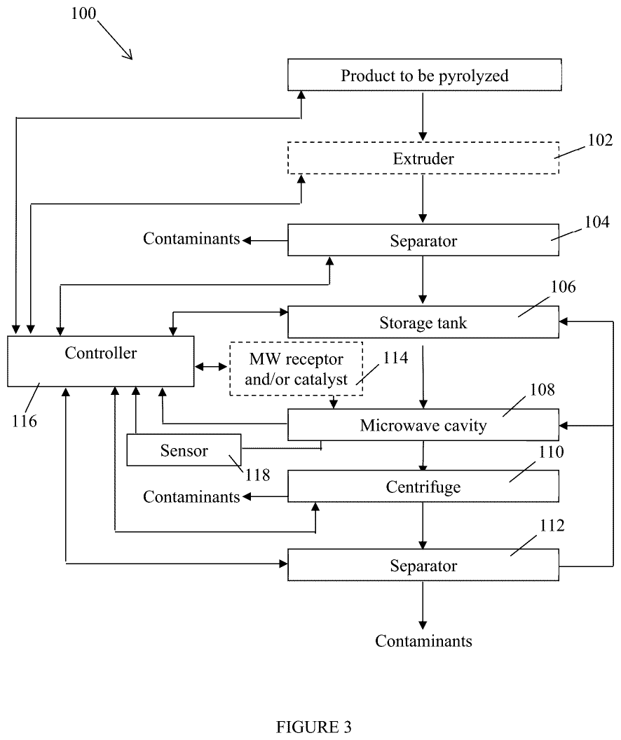

FIG. 3 illustrates another embodiment of a system 100 for performing the pyrolysis of a thermoplastic polymer. The system 100 comprises a source of product to be pyrolyzed, i.e., a source of thermoplastic polymer, an optional extruder 102, a first separator 104, a storage tank 106, a microwave cavity 108, a centrifuge 110, a second separator 112, an optional source of microwave receptor and/or catalyst 114, a controller 116 and a sensor 118.

The extruder 102 is connected to the source of thermoplastic polymer to receive thermoplastic polymer therefrom and melt the received thermoplastic polymer. The melted thermoplastic polymer is then separated by the first separator 104 to remove contaminants before being stored into the storage tank 106. Some melted thermoplastic polymer is then fed into the microwave cavity 108 and microwaves generated by a microwave source (not shown) and propagated along a microwave waveguide (not shown) are injected into the microwave cavity 108 to pyrolyze the thermoplastic polymer. The pyrolysis product exits the microwave cavity 108 and is separated by the centrifuge 110 and the second separator 112 to remove contaminants present in the pyrolysis product. At least some of the separated product is reinjected into the storage tank 106 and/or the microwave cavity 108. It should be understood that pumps are also present to propagate the different product between components of the system 100.

Similarly to the controller 20 of system 10, the controller 116 controls operation or control parameters of the other elements of the system 50. For example, the controller 62 may control the temperature of the extruder 102, the first and/or second separator 104 and 112, the centrifuge 110 and/or the storage tank 106, flow rates of products such as the flow rate of melted thermoplastic polymer injected into the microwave cavity 108 from the storage tank 106 or the flow rate of pyrolyzed product reinjected into the storage tank 106 and/or the microwave cavity 108, the flow rate of microwave receptor and/or catalyst injected into the microwave cavity 108 form the source of microwave receptor and/or catalyst 114, the bowl rotational speed and/or the differential speed of the centrifuge 110, etc.

Similarly to sensor 22, the sensor 118 is adapted to measure the complex reflection coefficient Γ of the system comprising the cavity of the microwave cavity 108, the waveguide and the microwave source.

Similarly to controller 22, the controller 116 is configured for controlling at least one control parameter of at least one component of the system 100 and/or triggering an alarm based on the measured value for the complex reflection coefficient, as described above. In one embodiment, the controller 116 is further configured for calculating a electromagnetic property of the mixture contained in the microwave cavity 108 such as the effective dielectric permittivity of the mixture and controlling at least one control parameter and/or triggering an alarm based on the calculated value of the electromagnetic property.

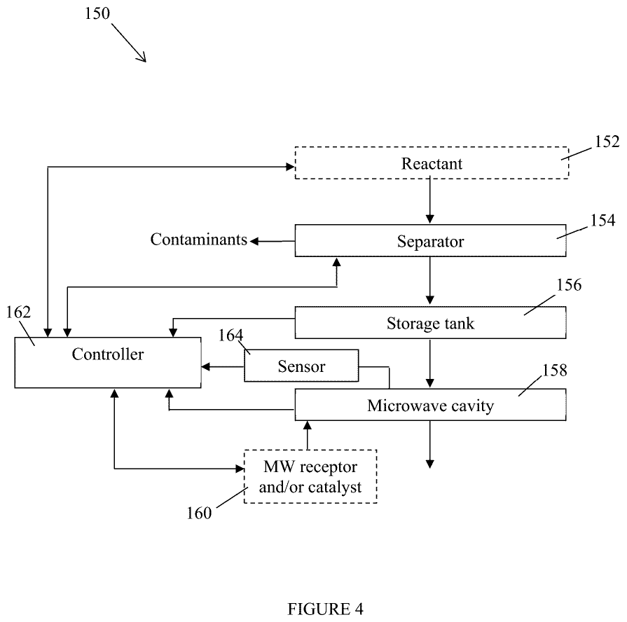

FIG. 4 illustrates another embodiment of a system 150 for performing the pyrolysis of a thermosetting polymer. The system 150 comprises a source of product to be pyrolyzed 152. i.e., a source of thermosetting polymer 152, a separator 154, a storage tank 156, a microwave cavity 158, an optional source of microwave receptor and/or catalyst 160, a controller 162 and a sensor 164.

The separator 154 is connected to the source of thermosetting polymer to receive and separator the thermosetting polymer. The separated thermosetting polymer is then stored into the storage tank 156. Some melted thermosetting polymer is then fed into the microwave cavity 158 and microwaves generated by a microwave source (not shown) and propagated along a microwave waveguide (not shown) are injected into the microwave cavity 158 to pyrolyze the thermosetting polymer. It should be understood that pumps are also present to propagate the different product between components of the system 150. Optionally, microwave receptors and/or catalyst can be injected into the microwave cavity 158.

Similarly to the controller 20 of system 10, the controller 116 controls operation or control parameters of the other elements of the system 50. For example, the controller 62 may control the temperature of the extruder 102, the first and/or second separator 104 and 112, the centrifuge 110 and/or the storage tank 106, flow rates of products such as the flow rate of melted thermoplastic polymer injected into the microwave cavity 108 from the storage tank 106 or the flow rate of pyrolyzed product reinjected into the storage tank 106 and/or the microwave cavity 108, the flow rate of microwave receptor and/or catalyst injected into the microwave cavity 108 form the source of microwave receptor and/or catalyst 114, the bowl rotational speed and/or the differential speed of the centrifuge 110, etc.

Similarly to sensor 22, the sensor 118 is adapted to measure the complex reflection coefficient Γ (or S₁₁) of the system comprising the cavity of the microwave cavity 108, the waveguide and the microwave source.

Similarly to controller 22, the controller 116 is configured for controlling at least one control parameter of at least one component of the system 100 and/or triggering an alarm based on the measured value for the complex reflection coefficient, as described above. In one embodiment, the controller 116 is further configured for calculating an electromagnetic property of the mixture contained in the microwave cavity 108 such as the effective dielectric permittivity of the mixture and controlling at least one control parameter and/or triggering an alarm based on the calculated value of the electromagnetic property.

It should be understood that controllable valves can be present within the system in order to control the different flows of product between the different components of the system 10, 50, 100.

In one embodiment, the substance within the microwave cavity is substantially homogenously mixed while the method for determining the composition of the substance is performed.

The inventors have realized that the complex reflection coefficient of a microwave system comprising at least a microwave cavity and a microwave source depends on the geometry of the microwave cavity. Therefore, a change in the microwave cavity geometry will induce a change in the complex reflection coefficient in a distinctive way since it will affect the microwave interactions occurring in the microwave cavity. Therefore, the above-described method and system may be adapted to detect a failure in the microwave system since a failure of the microwave system may be associated with a change in the geometry of the microwave cavity, and therefore to a change in the complex reflection coefficient. For example, a crack in a wall of the microwave cavity will change the geometry of the microwave cavity and induce a change in the complex reflection coefficient of the microwave cavity. Other examples of failure that change the geometry of the microwave cavity may include the breakage or displacement of any internal element or a combination of internal elements such as an agitator, a temperature transmitter, a pressure transmitter, a perforated plate, etc.

The method for detecting a failure comprises the steps of measuring the complex reflection coefficient of the microwave system comprising the microwave cavity and at least a microwave source, as described above, comparing the measured complex reflection coefficient to a set of predefined values for the complex reflection coefficient, and detecting the failure of the microwave system based on the comparison. Each predefined value for the complex reflection coefficient is indicative of a failure of the microwave system. Therefore, by comparing the measured complex reflection coefficient to the set of predefined complex reflection coefficients, a failure is detected when the measured complex reflection coefficient is substantially equal to a predefined complex reflection coefficient.

In one embodiment, each predefined value for the complex reflection coefficient is associated with a respective and different failure of the microwave system. In this case, the method further allows for identifying the particular failure that is occurring. When the result of the comparison step indicates that the measured complex reflection coefficient is substantially equal to a given predefined complex reflection coefficient, the particular failure that is occurring is identified as being the failure associated with the given predefined complex reflection coefficient.

Once the failure of the microwave system has been detected, an action is triggered. For example, an alarm may be triggered to inform a user of the microwave system that a failure of the microwave system occurred. In the same or another example, the action may consist in the shutdown of the microwave system.

In an embodiment, in which the method comprises the step of identifying the particular failure that is occurring, the method may further comprise a step of outputting an identification of the identified failure such as an identification of the source or origin of the failure.

In one embodiment, the predefined complex reflection coefficients are stored in a database and each predefined complex reflection coefficient is associated with a respective configuration of internal microwave cavity geometry due to a respective failure. The predefined complex reflection coefficients can be assessed experimentally or through modeling or simulation to form the database of predefined complex reflection coefficients and a respective failure is associated to each predefined complex reflection coefficient in the database.

It should be understood that the microwave system, the substance contained in the microwave cavity and the operation conditions of the microwave system arc identical for all predefined complex reflection coefficients so that the difference between the predefined complex reflection coefficients is only due to changes in the geometry microwave cavity.

As mentioned above, the present method for detecting a failure of a microwave system may be used for detecting a crack in a wall of a microwave cavity. In another example, the method may be used for detecting the failure of an agitator installed in a microwave cavity for mixing the substance contained in the microwave cavity. The geometry of the microwave cavity is considered to be different depending on the operation conditions of the agitator. The database of predefined complex reflection coefficients comprise at least one predefined value associated with a case in which the agitator is operating normally and another predefined value associated with the case in which the agitator does not operate. The database may also comprise predefined complex reflection coefficients for different speeds of rotation. Therefore, if the measured complex reflection coefficient corresponds to the predefined complex reflection coefficient associated with the case in which the agitator does not operate, then a failure of the agitator may be identified.

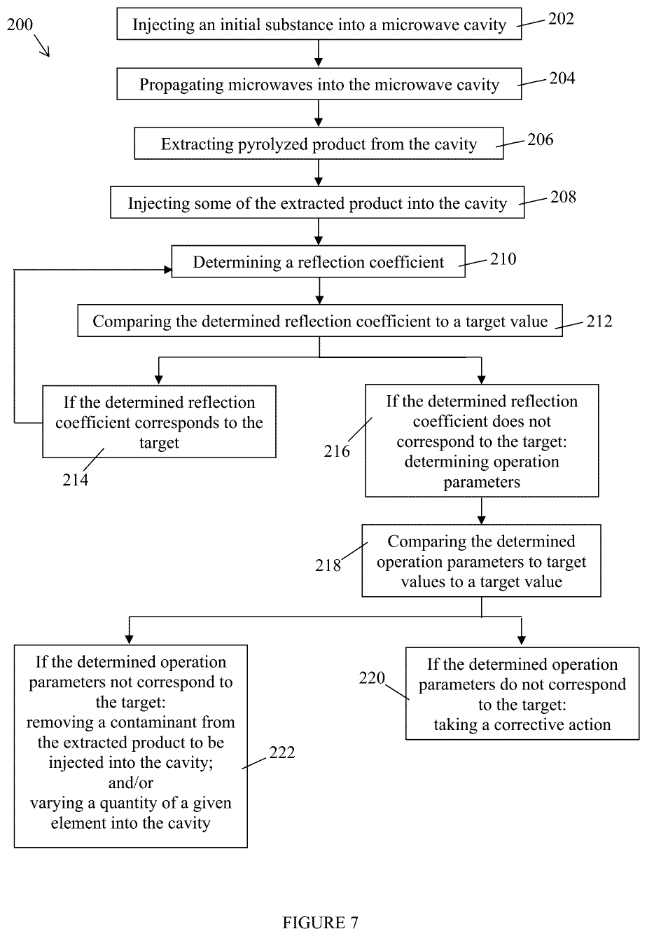

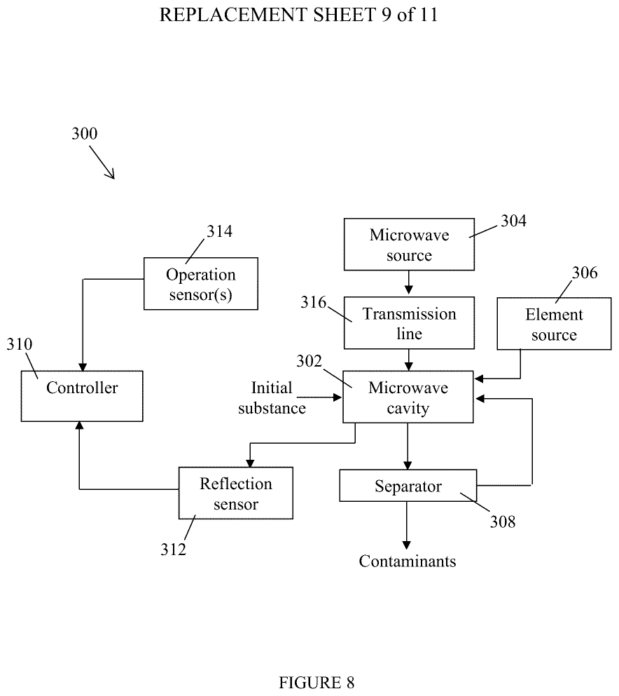

In the following, there is described a method 200 for controlling a microwave assisted treatment, as illustrated in FIG. 7. The method 200 is described in connection with the microwave system 300 illustrated in FIG. 8. However, the person skilled in the art will understand that another microwave system may be used for performing the method 200.

At step 202, an initial substance having a given composition and to be treated is injected into the microwave cavity 302. In one embodiment, some initial substance is substantially continuously injected into the cavity 302 at a given flow rate which may vary in time. In one embodiment, the system 300 further comprises a storage tank (not shown) fluidly connected to the cavity 302 for storing the initial substance.

At step 204, microwaves generated by the microwave source 304 are propagated into the cavity 302 containing the initial substance via the transmission line 306 in order to execute the microwave treatment of the initial substance such as a pyrolysis of the initial substance. As described above, the transmission line 306 may comprise a microwave waveguide, a coupler, a tuner, etc. Under the influence of the microwaves, the initial substance contained in the cavity 302 is microwave-treated, thereby obtaining a treated substance such as a pyrolyzed substance.

At step 206, some of the treated substance is extracted from the cavity 302 and some of the extracted substance is reinjected into the cavity 302 for further treatment. In the illustrated system embodiment, the system comprises a separator 308 fluidly connected to the output of the cavity 302 and to an input of the cavity 302 in order to reinject part of the substance extracted from the cavity 302 into the cavity 302. As described above, the separator 308 is used for extracting a component such as a contaminant from the extracted substance. In one embodiment, the contaminant extracted by the separator 308 is carbon black.

As described above, the separator 308 may comprise a centrifuge, a filter, desorption device, an adsorption device, etc. or a combination of such components.

At step 208, the portion of the treated substance that propagated through the separator 308 is reinjected into the cavity 302 for further microwave treatment.

At step 210, the complex reflection coefficient of the microwave system 300 is measured using the sensor 312. As described above, the complex reflection coefficient is measured at the port of the cavity 302 through which the microwaves arc injected into the cavity 302. For example, the complex reflection coefficient may be measured at the interface between the cavity 302 and the transmission line 306 such as at the interface between the cavity 302 and a waveguide. When the transmission line 308 comprises a coupler between the waveguide and the cavity 302, the complex reflection coefficient may be measured at the interface between the cavity 302 and the coupler. A sensor 312 such as a reflectometer or a network analyzer may be used for measuring the complex reflection coefficient.

As illustrated in FIG. 8, the system 300 comprises a controller 310. The controller 310 comprises a database having stored therein reference or target values for the complex reflection coefficient for different initial substance compositions and different normal or target operation parameters for the microwave treatment of the initial substance. Operation parameters define the operation conditions for treating an initial substance having a given composition. The controller 310 is configured for retrieving the target value for the complex reflection coefficient that corresponds to the given composition of the initial substance to be treated and the operation conditions for treating the initial substance, i.e., the operation parameters defining the operation conditions.

In one embodiment, the operation parameters comprise:
the frequency of the microwaves propagated into the microwave cavity 302;
the net power of the microwaves propagated into the microwave cavity 302;
the geometry of the microwave cavity 302;
the level of the substance contained within the cavity 302, i.e., of the initial substance undergoing the microwave-assisted treatment within the microwave cavity 302;
the temperature of the substance contained within the cavity 302;
the temperature of the microwave receptors, when microwave receptors are present; and/or
the rotation speed of an agitator contained within the microwave cavity 302, when an agitator is contained within the cavity 302.

In one embodiment, the operation parameters comprise at least the frequency of the microwaves, the net power of the microwaves, the level of the substance contained within the cavity 302 and the temperature of the substance contained within the cavity 302. In another embodiment, the operation parameters further comprise at least one of the following parameters: the geometry of the microwave cavity 302, the temperature of the microwave receptors and the rotation speed of the agitator.

In one embodiment, the cavity 302 comprises movable elements such as a movable choke plate or movable microwave receptors in the shape of rods for example. In this case, the person skilled in the art will understand that geometry of the cavity may change depending on the presence/absence and the position of the movable elements and the geometry of the cavity 302 may be defined by the position of the movable elements. In another embodiment, the cavity 302 may comprise no movable part such as its geometry may not change. In this case, the geometry of the cavity 302 may remain constant and may not be part of the operation parameters.

After retrieving the target complex reflection coefficient, the controller 310 is configured for comparing the measured complex reflection coefficient to the retrieved target complex reflection coefficient at step 212.

At step 214, if the measured complex reflection coefficient substantially corresponds to the target complex reflection coefficient, then the method returns to step 210, i.e. the complex reflection coefficient of the microwave system 300 is measured again.

It should be understood that the target complex reflection coefficient may be defined as a single target value or a range of target values.

At step 216, if the measured complex reflection coefficient does not correspond to the target complex reflection coefficient, then the actual operation parameters of the microwave system 300 are determined. The system 300 comprises at least one sensor 314 for measuring at least one operation parameter. For example, the system 300 may comprise a frequency probe for measuring the frequency of the microwaves injected into the cavity 302. The frequency probe may be located within the waveguide connecting the microwave source 304 to the cavity 302 for example. The system 300 may further comprise position sensors and/or positioners for determining the presence/absence and position of movable elements in the cavity 302, and thereby determining the actual geometry of the cavity 302. The system 300 may also comprise a level sensor for determining the level of the initial substance being treated in the cavity. For example, a level sensor may be a radar level sensor, an hydrostatic pressure level sensor, a magnetorestrictive level sensor, a time domain reflectometry (TDR) level sensor. The system 300 may also comprise a first temperature sensor for measuring the temperature of the initial substance being treated and a second temperature sensor for measuring the temperature of the microwave receptor(s). For example, a temperature sensor may be a resistance temperature detector (RTD), a thermocouple, an infrared sensor, etc. The system 300 may further comprise a sensor for measuring the rotation speed of an agitator such as a variable frequency drive (VFD), a tachometer, an encoder, etc.

At step 218, the controller 310 retrieves the target operation parameters associated with the given composition for the initial substance and compares the measured operation parameters to the retrieved target operation parameters. It should be understood that a target operation parameter may be defined by a single target value or a range of target values.

At step 220, if the measured operation parameters do not correspond to the target operation parameters, i.e., if at least one of the measured operation parameters does not correspond to its respective target operation parameter, a problem with the operation conditions is detected and a corrective action is taken by the controller 310. In one embodiment, the corrective action consists in triggering an alarm. In another embodiment, the corrective action consists in stopping the operation of the microwave system 300. In a further embodiment, the corrective action consists in adjusting the operation parameter of which the measured value does not correspond to the target value. For example, the controller 310 may be adapted to control the microwave source 304. If it is determined that the measured frequency of the microwaves does not correspond to the target frequency, the controller 301 may control the microwave source 304 to adjust the frequency of the emitted microwaves to the target frequency.

At step 222, if the measured operation parameters correspond to the target operation parameters, i.e., if each measured operation parameter corresponds to its respective target operation parameter, it is then detected that a problem unrelated to the operation conditions is occurring. In this case, the controller 310 may control the separator 308 to remove contaminants from the portion of the treated substance that is extracted from the cavity 302 and reinjected into the cavity 302 and/or control a source 316 of a given element to control the quantity of the given substance into the cavity 302, in order to bring the complex reflection coefficient to its target value.

In one embodiment, the separator 308 may be inoperative at the beginning of the method 200. In this case, at step 222, the controller 310 activates the separator 308 in order to remove a contaminant such as carbon black from the portion of the extracted substance to be reinjected into the cavity 302, and thereby bringing the complex reflection coefficient to its target value. In an embodiment in which the separator 308 is already in operation at step 222, the controller 310 controls the separator 308 in order to increase the amount of contaminant that is removed from the portion of the extracted substance to be reinjected into the cavity 302.

In one embodiment, the controller 310 is further configured for determining the rate of production of the contaminant within the cavity 302 based on the measured complex reflection coefficient in time and controlling the separator 308 based on the determined rate of production of the contaminant. In an embodiment in which the separator 308 comprises a centrifuge, the controller 310 may be configured for controlling the temperature, the bowl rotational speed and/or the differential speed of the centrifuge based on the determined rate of production of the contaminant. In an embodiment in which separator 308 comprises a filter, the controller 310 may be configured for controlling the mesh size of the filter and/or the cleaning sequence for the filter.

In another embodiment, the controller 310 is further configured for determining the rate of production of the contaminant within the cavity 302 based on the measured complex reflection coefficient in time and controlling the flow rate of the treated substance extracted from the cavity 302 and provided to the separator 308 based on the determined rate of production of the contaminant. For example, the controller 310 may control a pump that is installed along the fluidic connection between the output of the cavity 302 and the separator 308 and used for extracting some of the treated substance from the cavity 302.

Referring back to FIG. 8, the system 300 comprises the source 316 of the given element that is fluidly connected to the cavity 302. The given element correspond to an element that has an impact on the complex reflection coefficient and comprises a catalyst, a microwave receptor, a reagent or an additive. At step 222, the controller 310 is configured for varying the amount or quantity of the given element within the cavity 302. For example, the controller 310 may control the source 316 to increase or decrease the flow rate at which the given element is injected into the cavity 302 in order to increase or decrease, respectively, the quantity of the given element within the cavity 302. In one embodiment, the controller 310 is configured for calculating the amount of given element to be added or removed based on the measured complex reflection coefficient, as described above, and adjust the flow rate to provide the cavity 302 with the calculated amount of given element.

In one embodiment, the controller 310 is configured for using a feedback loop to remove the contaminant and/or adding or removing the given element in order to bring the measured complex reflection coefficient to its target value.

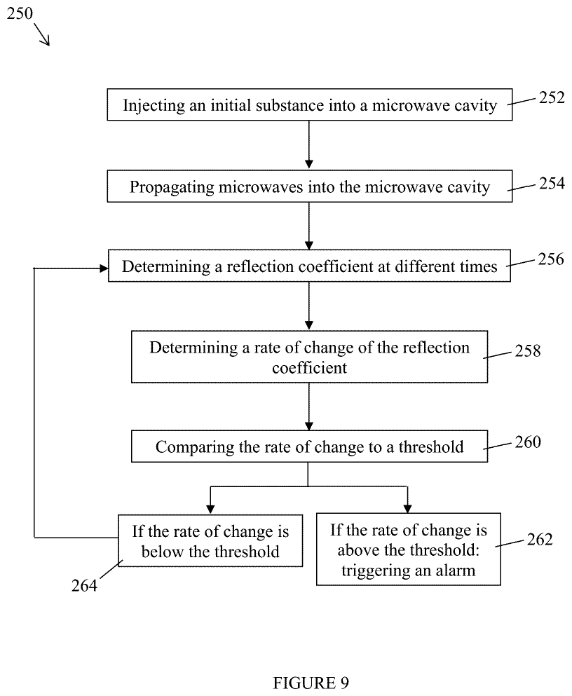

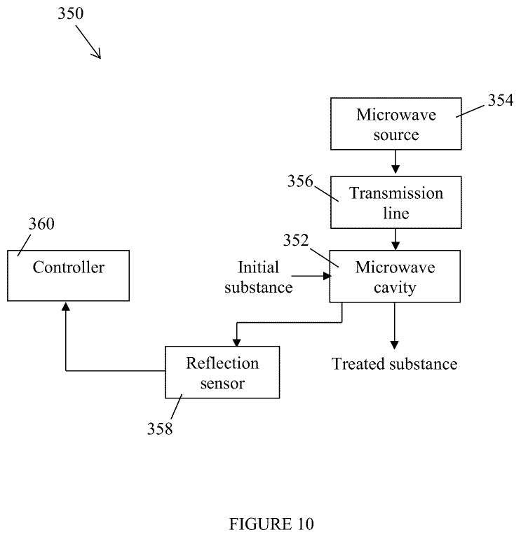

FIG. 9 illustrates a further method 250 for controlling a microwave-assisted treatment. The method 250 is described in connection with the microwave system 350 illustrated in FIG. 10. However, the person skilled in the art will understand that another microwave system may be used for performing the method 250.

At step 252, an initial substance having a given composition and to be treated is injected into the microwave cavity 352. In one embodiment, some initial substance is substantially continuously injected into the cavity 302 at a given flow rate which may vary in time. In one embodiment, the system 350 further comprises a storage tank (not shown) fluidly connected to the cavity 302 for storing the initial substance. The initial substance is then injected into the cavity 352 from the storage tank.

At step 254, microwaves generated by the microwave source 354 are propagated into the cavity 352 containing the initial substance via the transmission line 356 in order to execute the microwave treatment of the initial substance such as a pyrolysis of the initial substance. As described above, the transmission line 356 may comprise a microwave waveguide, a coupler, a tuner, etc. Under the influence of the microwaves, the initial substance contained in the cavity 352 is microwave-treated, thereby obtaining a treated substance such as a pyrolyzed substance.

At step 256, the complex reflection coefficient of the microwave system 350 is measured at different points in time using the sensor 358. As described above, the complex reflection coefficient is measured at the port of the cavity 352 through which the microwaves are injected into the cavity 352. For example, the complex reflection coefficient may be measured at the interface between the cavity 352 and the transmission line 356 such as at the interface between the cavity 352 and a waveguide. When the transmission line 358 comprises a coupler between the waveguide and the cavity 352, the complex reflection coefficient may be measured at the interface between the cavity 352 and the coupler. A sensor 358 such as a reflectometer or a network analyzer may be used for measuring the complex reflection coefficient.

As illustrated in FIG. 10, the system 300 comprises a controller 360 in communication with the sensor 358. The controller 360 is configured for calculating the rate of change of the complex reflection coefficient using the complex reflection coefficient measured at least two different points in time by the sensor 358 at step 258.

The controller 360 comprises or has access to a database having stored therein threshold values for a rate of change of the complex reflection coefficient for different initial substance compositions. The controller 360 is configured for retrieving the threshold value for the rate of change complex reflection coefficient that corresponds to the given composition of the initial substance to be treated.

At step 260, the controller 360 compares the determined rate of change of the complex reflection coefficient to the threshold value retrieved from the database for the given composition of the initial substance.

At step 262, if the determined rate of change of the complex reflection coefficient is equal to or above the threshold value, the controller 360 triggers an alarm.

In one embodiment, the triggering of the alarm corresponds to the shutting down of the microwave system 350. In this case, upon determining that the determined rate of change of the complex reflection coefficient is equal to or above the threshold value, the controller 360 controls the microwave source 354 for stopping the generation of microwaves and may also control the source of initial substance, such as a storage tank, to stop injecting initial substance into the cavity 352.

In one embodiment, the database further comprises a respective cause of failure for different values of rate of change above the threshold. In this case, the controller 360 is further configured for accessing the database and retrieving the cause of failure associated with the determined rate of change of the complex reflection coefficient. The controller 360 may then inform a user of the cause of failure such as by displaying the cause of failure on a display unit.

At step 264, if the determined rate of change of the complex reflection coefficient is below the threshold value, the method returns to step 256 and the reflection coefficient is measured again.

In one embodiment, the complex reflection coefficient is measured substantially continuously. In another embodiment, the complex reflection coefficient is measured iteratively at different points in time.

In an embodiment in which the microwave system 350 further comprises a separator such as the separator 308 for reinjecting into the cavity 352 at least a portion of the treated substance, as described above, and a source of a given element such as the source 316, the method 250 further comprises the steps 206 and 208 of the method 200 to reinject part of the treated substance into the cavity 352. In this case, the controller 360 may further configured for executing the steps 210-222 of the method 200 when the determined rate of change of the complex reflection coefficient is below the threshold.

While in the above description, the complex reflection coefficient of a microwave system is used in the methods 200 and 250, the person skilled in the art will understand that the complex transmission coefficient of the microwave system may be used in replacement of the complex reflection coefficient in a similar manner. Therefore, in one embodiment, the complex reflection coefficient comprises or corresponds tot eh complex transmission coefficient. When a microwave cavity is provided with at least one additional port in addition to the port used for injecting the microwaves, the complex transmission coefficient may be measured at this additional port. The person skilled in the art would understand that the complex transmission coefficient is equivalent to the complex reflection coefficient since the above-described methods can be executed based on the complex reflection coefficient or based on the complex transmission coefficient. When the complex transmission coefficient is used, the steps 210 and 256 comprises the measurement of the complex transmission coefficient at a port of the cavity other than input port through which microwaves are injected. At step 212, the measured complex transmission coefficient is compared to a target value. If the measured complex transmission coefficient does not corresponds to the target value, then steps 216-222 are executed. At step 258, the rate of change of the complex transmission coefficient is determined and compared to a threshold at step 260.

Modifications and improvements to the above-described implementations of the present technology may become apparent to those skilled in the art. The foregoing description is intended to be exemplary rather than limiting.

1. A method for controlling a microwave-assisted treatment, the method comprising:
injecting an initial substance having a given composition into a microwave cavity;
propagating microwaves into the microwave cavity according to given operation parameters, thereby obtaining a treated substance;
extracting some of the treated substance from the microwave cavity;
injecting at least part of the extracted treated substance into the microwave cavity;
measuring a complex reflection coefficient of a microwave system comprising the microwave cavity and at least a microwave source;
comparing the measured complex reflection coefficient to a target coefficient value for the given composition of the initial substance and for the given operation parameters;
when the measured complex reflection coefficient is different from the target coefficient value, measuring operation parameters of the microwave system;
comparing the measured operation parameters to the given operation parameters;
when the measured operation parameters correspond to the given operation parameters, at least one of:
removing a contaminant from the at least a part of the treated substance prior to said injecting the at least a part of the treated substance into the microwave cavity; and
varying a quantity of a given element within the microwave cavity, the given element comprising one of a catalyst, a microwave receptor, a reagent and an additive.

2. (canceled)

3. The method of claim 1, wherein said removing the contaminant comprises propagating the at least a part of the treated substance into a separator, thereby obtaining a separated substance, the separated substance being injected into the microwave cavity, the method further comprising determining a rate of production of the contaminant within the microwave cavity based on the measured complex reflection coefficient, and one of:
controlling the separator based on the determined rate of production; and
adjusting a flow rate of the at least a part of the treated substance provided to the separator based on the determined rate of production.

4. (canceled)

5. (canceled)

6. The method of claim 3, wherein said propagating the at least a part of the treated substance into the separator comprises propagating the at least a part of the treated substance into a centrifuge, the method further comprising determining a rate of production of the contaminant within the microwave cavity based on the measured complex reflection coefficient and controlling at least one of a temperature, a bowl rotational speed and a differential speed for the centrifuge based on the determined rate of production.

7. (canceled)

8. The method of claim 3, wherein said propagating the at least a part of the treated substance into the separator comprises filtering the at least a part of the treated substance using a filter, the method further comprising determining a rate of production of the contaminant within the microwave cavity based on the measured complex reflection coefficient and adjusting at least one of a mesh size and a filter cleaning sequence for the filter based on the determined rate of production.

9.-12. (canceled)

13. The method of claim 1, wherein said measuring the operation parameters comprising determining at least one of:
a frequency of the microwaves propagated into the microwave cavity;
a net power of the microwaves propagated into the microwave cavity;
a geometry of the microwave cavity;
a level of the initial substance undergoing the microwave-assisted treatment within the microwave cavity;
a first temperature of the initial substance undergoing the microwave-assisted treatment within the microwave cavity;
a second temperature of the microwave receptor; and
a rotation speed of an agitator contained within the microwave cavity.

14.-16. (canceled)

17. The method of claim 1, wherein said measuring the complex reflection coefficient is performed at one of:
an interface between the microwave cavity and the microwave source, and
when the microwave system further comprises a coupler installed between the microwave source the microwave cavity, an interface between the microwave cavity and the coupler.

18. (canceled)

19. A microwave system for performing a microwave-assisted treatment, the system comprising:
a microwave cavity for receiving an initial substance having a given composition, the microwave being operatively connected to at least a microwave source for propagating microwaves into the microwave cavity according to given operation parameters to obtain a treated substance;
a separator fluidly connected to the microwave cavity for receiving at least a part of the treated substance therefrom, removing a contaminant from the at least a part of the treated substance to obtain a separated substance and injecting the separated substance into the microwave cavity;
a source of a given element fluidly connected to the microwave cavity for injecting the given element into the microwave cavity, the given element comprising one of a catalyst, a microwave receptor, a reagent and an additive;
a coefficient sensor for measuring a complex reflection coefficient of the microwave system;
at least one operation sensor for measuring operation parameters of the microwave system; and
a controller for:
comparing the measured complex reflection coefficient to a target coefficient value for the given composition of the initial substance and for the given operation parameters;
when the measured complex reflection coefficient is different from the target coefficient value, controlling the at least one operation sensor for measuring the operation parameters of the microwave system;
comparing the measured operation parameters to the given operation parameters;
when the measured operation parameters correspond to the given operation parameters, at least one of:
removing a contaminant from the at least a part of the treated substance prior to said injecting the at least a part of the treated substance into the microwave cavity; and
varying a quantity of the given element within the microwave cavity.

20. (canceled)

21. (canceled)

22. The microwave system of claim 19, wherein the controller is further configured for determining a rate of production of the contaminant within the microwave cavity based on the measured complex reflection coefficient and one of:
controlling the separator based on the determined rate of production; and
adjusting a flow rate of the at least a part of the treated substance provided to the separator based on the determined rate of production.

23. (canceled)

24. The microwave system of claim 19, wherein the separator comprises a centrifuge and the controller is further configured for determining a rate of production of the contaminant within the microwave cavity based on the measured complex reflection coefficient and controlling at least one of a temperature, a bowl rotational speed and a differential speed for the centrifuge based on the determined rate of production.

25. (canceled)

26. The microwave system of claim 19, wherein the separator comprises a filter and the controller is further configured for determining a rate of production of the contaminant within the microwave cavity based on the measured complex reflection coefficient and adjusting at least one of a mesh size and a filter cleaning sequence for the filter based on the determined rate of production.

27.-30. (canceled)

31. The microwave system of claim 19, wherein the operation parameters comprise at least one of:
a frequency of the microwaves propagated into the microwave cavity;
a net power of the microwaves propagated into the microwave cavity;
a geometry of the microwave cavity;
a level of the initial substance undergoing the microwave-assisted treatment within the microwave cavity;
a first temperature of the initial substance undergoing the microwave-assisted treatment within the microwave cavity;
a second temperature of the microwave receptor; and
a rotation speed of an agitator contained within the microwave cavity.

32. (canceled)

33. (canceled)

34. The microwave system of claim 19, wherein the coefficient sensor comprises one of a reflectometer and a network analyzer.

35. A method for detecting a failure in a microwave system comprising at least a microwave cavity and a microwave source during a microwave-assisted treatment of a mixture, the method comprising:
injecting an initial substance having a given composition into the microwave cavity;
propagating microwaves into the microwave cavity, thereby obtaining a treated substance;
measuring a complex reflection coefficient of a microwave system at different points in time, the microwave system comprising the microwave cavity and at least a microwave source;
determining a rate of change of the measured complex reflection coefficient;
comparing the determined rate of change to a threshold value for the given composition; and
when the determined rate of change is above the threshold value, triggering an alarm.

36. The method of claim 35, wherein a value of the rate of change of the measured complex reflection coefficient above the threshold value is indicative of a given cause of failure of the microwave system and said triggering the alarm comprises outputting an identification of the given cause of failure.

37. (canceled)

38. The method of claim 35, wherein said triggering the alarm comprises shutting down the microwave system.

39. The method of claim 35, further comprising:
extracting some of the treated substance from the microwave cavity;
injecting at least part of the extracted treated substance into the microwave cavity; and
when the determined rate of change is below the threshold value:
comparing the measured complex reflection coefficient to a target coefficient value for the given composition of the initial substance and for given operation parameters of the microwave system;
when the measured complex reflection coefficient is different from the target coefficient value, measuring operation parameters of the microwave system;
comparing the measured operation parameters to the given operation parameters; and
when the measured operation parameters correspond to the given operation parameters, at least one of:
removing a contaminant from the at least a part of the treated substance prior to said injecting the at least a part of the treated substance into the microwave cavity; and
varying a quantity of a given element within the microwave cavity, the given element comprising one of a catalyst, a microwave receptor, a reagent and an additive.

40.-45. (canceled)

46. A microwave system for performing a microwave-assisted treatment, the system comprising:
a microwave cavity for receiving an initial substance having a given composition, the microwave being operatively connected to at least a microwave source for propagating microwaves into the microwave cavity to obtained a treated substance;
a coefficient sensor for measuring a complex reflection coefficient of the microwave system at different points in time; and
a controller for:
determining a rate of change of the measured complex reflection coefficient;
comparing the determined rate of change to a threshold value for the given composition; and
when the determined rate of change is above the threshold value, triggering an alarm.

47. The microwave system of claim 46, wherein a value of the rate of change of the measured complex reflection coefficient above the threshold value is indicative of a given cause of failure of the microwave system and the controller is further configured for outputting an identification of the given cause of failure.

48. (canceled)

49. The microwave system of claim 46, wherein the controller is configured for shutting down the microwave system.

50. The microwave system of claim 46, further comprising:
a separator fluidly connected to the microwave cavity for receiving at least a part of the treated substance therefrom, removing a contaminant from the at least a part of the treated substance said to obtain a separated substance and injecting the separated substance into the microwave cavity;
a source of a given element fluidly connected to the microwave cavity for injecting the given element into the microwave cavity, the given element comprising one of a catalyst, a microwave receptor, a reagent and an additive; and
at least one operation sensor for measuring operation parameters of the microwave system;
wherein when the determined rate of change is below the threshold value, the controller is further configured for:
comparing the measured complex reflection coefficient to a target coefficient value for the given composition of the initial substance and for given operation parameters of the microwave system;
when the measured complex reflection coefficient is different from the target coefficient value, measuring operation parameters of the microwave system;
comparing the measured operation parameters to the given operation parameters;
when the measured operation parameters correspond to the given operation parameters, at least one of:
removing a contaminant from the at least a part of the treated substance prior to said injecting the at least a part of the treated substance into the microwave cavity; and
varying a quantity of a given element within the microwave cavity.

51.-56. (canceled)
